(19) United States
(12) Patent Application Publication
(10) Pub. No.: US 2016/0086275 A1
(43) Pub. Date: Mar. 24, 2016

(54) COMPUTERIZED TECHNIQUES FOR FACILITATING EXCHANGE OF A WATER RESOURCE

(71) Applicant: Sourcewater, Inc., Boston, MA (US)

(72) Inventor: Josh ADLER, Rye, NH (US)

(21) Appl. No.: 14/864,305

(22) Filed: Sep. 24, 2015

Related U.S. Application Data
(60) Provisional application No. 62/054,573, filed on Sep. 24, 2014.

(51) Int. Cl. G06Q 40/04

(52) U.S. Cl. CPC G06Q 40/04

(57) ABSTRACT

Computer-implemented systems, methods, and computer-readable media are provided for facilitating an exchange of a water resource. The computer-implemented systems, methods, and computer-readable media may, for example, receive first information identifying a plurality of attributes regarding a water resource to be offered for sale, receive second information identifying a plurality of attributes regarding a water resource need, automatically calculate a cost associated with providing the water resource, automatically generating a transaction proposal based on the calculated cost, and providing the transaction proposal to a first or second client device for presentation.

### RELATED APPLICATIONS

This application claims priority under 35 U.S.C. 119(e) to U.S. Provisional Patent Application No. 62/054,573, entitled Online Water Exchange Platform, which was filed on Sep. 24, 2014, the contents of which are incorporated herein by reference in their entirety.

### TECHNICAL FIELD

The present disclosure relates to computerized systems and methods for facilitating the exchange of a water resource, and more generally, to techniques for facilitating the exchange of a resource over a computer network. By way of example, and without limitation, the present disclosure relates to computerized systems and methods for facilitating a transaction of a water resource over a network.

### BACKGROUND

Entities, such as companies or individuals, often have resources at their disposal. Other entities, such as other companies or individuals, may desire these resources. Entities that have resources may trade them with entities that need resources for some sort of compensation, such as monetary compensation. For example, an owner of water resources may sell the water resources to a prospective buyer. Such a transaction benefits the prospective buyer by giving him/her access to the water resources. The transaction also benefits the owner by providing him/her with compensation for his/her loss of control over the water resources.

Resources may not always be efficiently transacted in a manner that best benefits the owner and prospective buyer. For example, in the case of water resources, the needs of a business that uses the water resources may change on a regular basis. For example, an estimate that a certain amount of a water resource is needed for a day may no longer be correct as the day wears on, and a company may find themselves with an excess of a water resource. Moreover, a prospective buyer may be interested in comparing characteristics of a variety of different water resources that are available before making his/her decision on which to purchase.

### SUMMARY

Embodiments of the present disclosure relate to computerized systems and methods for facilitating an exchange of a water resource. In addition, embodiments of the present disclosure relate to facilitating an exchange of a water resource over a network.

In accordance with certain embodiments of the present disclosure, computerized systems and methods are provided that receive first information identifying a plurality of attributes regarding a water resource to be offered for trade, receive second information identifying a plurality of attributes regarding a water resource need, automatically calculate a cost associated with providing the water resource to be offered for trade to an entity with the water resource need, automatically generate a transaction proposal based on the cost, and provide the transaction proposal to a client device for presentation to the entity.

In accordance with some embodiments, there is provided a computer-implemented method for facilitating an exchange of a water resource. The method comprises receiving over a network, by a computing device including a memory and a processor configured to execute instructions stored in the memory, first information identifying a plurality of attributes regarding a water resource to be offered for trade, wherein the first information is received from a client device associated with a first entity that controls the water resource. The method also comprises receiving, by the computing device over the network, second information identifying a plurality of attributes regarding a water resource need, wherein the second information is received from a second client device associated with a second entity that has the water resource need. The method further comprises automatically calculating, by the processor, a cost associated with providing the water resource controlled by the first entity to the second entity based on the first information and the second information. The method still further comprises automatically generating, by the processor, a transaction proposal based on the calculated cost, and providing the transaction proposal to the first client device for presentation to the first entity, or to the second client device for presentation to the second entity.

In accordance with other aspects of the disclosure, the water resource to be offered for trade is a first water resource to be offered for trade, the cost is a first cost, and the transaction proposal is a first transaction proposal, and the method further comprises receiving over the network, by the computing device, third information identifying a plurality of attributes regarding a second water resource to be offered for trade, wherein the third information is received from a third client device associated with a third entity that controls the second water resource. The method also comprises automatically calculating, by the processor, a second cost associated with providing the second water resource to the second entity based on the third information and the first information. The method further comprises automatically generating, by the processor, a second transaction proposal based on the second cost. The method still further comprises providing the second transaction proposal to the third client device for presentation to the third entity, or to the second client device for presentation to the second entity.

In accordance with additional aspects of the disclosure, the plurality of attributes identified by the first information includes an attribute indicative of a location of the water resource to be offered for trade, an attribute indicative of an availability of the water resource to be offered for trade, and an attribute indicative of a trade condition of the water resource to be offered for trade.

In accordance with further aspects of the disclosure, the plurality of attributes identified by the second information includes an attribute indicative of a location of the water resource need, an attribute indicative of a condition of the water resource need, and an attribute indicative of a trade condition of the water resource need.

In accordance with still further aspects of the disclosure, the cost is a first cost, and the method further comprises receiving over the network, by the computing device, third information identifying a plurality of attributes regarding a transportation resource to be offered for trade, wherein the third information is received from a third client device associated with a third entity that controls the transportation resource. The method also comprises automatically calculating, by the processor, a second cost associated with providing the water resource controlled by the first entity to the second entity based on the third information. The method further comprises automatically calculating, by the processor, the first cost associated with providing the water resource controlled by the first entity to the second entity based on the second cost, the first information, and the second information.

In accordance with other aspects of the disclosure, the method further comprises receiving over the network, by the computing device, third information indicative of an offer proposed by the first entity or the second entity based on the transaction proposal, the third information identifying a plurality of attributes relating to the offer.

In accordance with still other aspects of the disclosure, the method also comprises receiving over the network, by the computing device, fourth information indicative of a term or condition related to the offer.

In accordance with additional aspects of the disclosure, the method also comprises providing over the network, by the computing device, a contract template to the first client device or the second client device, wherein the contract template includes the term or condition.

In accordance with other aspects of the disclosure, the method also comprises automatically generating, by the processor, an order for the water resource controlled by the first entity by the second entity based on the contract template.

In accordance with further aspects of the disclosure, the attribute indicative of the availability of the water resource to be offered for trade includes at least one of the following: a volume of the water resource that is available, a date on which the water resource is available, a type of the water resource that is available, and a quality metric of the water resource that is available.

In accordance with still further aspects of the disclosure, the attribute indicative of the trade condition includes at least one of the following: a price of the water resource that is available, a type of trade for the water resource that is available, and a business negotiation method for the water resource that is available.

In accordance with other aspects of the disclosure, the attribute indicative of a condition of the water resource need includes at least one of the following: a volume of the water resource needed, a date on which the water resource is needed, a type of the water resource needed, and a quality of the water resource needed.

In accordance with still other aspects of the disclosure, the attribute indicative of a trade condition of the water resource includes at least one of the following: a price of the water resource needed, a type of trade for the water resource needed, and a business negotiation method for the water resource needed.

In accordance with further aspects of the disclosure, the plurality of attributes regarding the transportation resource to be offered for trade includes at least one of the following: a type of transportation, a loading time, a loading cost, and a price of transportation.

Furthermore, in accordance with some embodiments, there is provided a computer-implemented system for facilitating an exchange of a water resource, comprising one or more memory devices that store instructions, and one or more processors that execute the instructions. The one or more processors execute the instructions to receive over the network first information identifying a plurality of attributes regarding a water resource to be offered for trade, wherein the first information is received from a first client device associated with a first entity that controls the water resource. The one or more processors also execute the instructions to receive over the network second information identifying a plurality of attributes regarding a water resource need, wherein the second information is received from a second client device associated with a second entity that has the water resource need. The one or more processors further execute the instructions to automatically calculate a cost associated with providing the water resource controlled by the first entity to the second entity based on the first information and the second information. The one or more processors still further execute the instructions to automatically generate a transaction proposal based on the calculated cost, and to provide the transaction proposal to the first client device for presentation to the first entity, or to the second client device for presentation to the second entity.

In accordance with other aspects of the disclosure, the water resource to be offered for trade is a first water resource to be offered for trade, the cost is a first cost, and the transaction proposal is a first transaction proposal, and the one or more processors further execute the instructions to receive over the network third information identifying a plurality of attributes regarding a second water resource to be offered for trade, wherein the third information is received from a third client device associated with a third entity that controls the second water resource. The one or more processors also execute the instructions to automatically calculate a second cost associated with providing the second water resource to the second entity based on the third information and the first information. The one or more processors further execute the instructions to automatically generate a second transaction proposal based on the second cost, and to provide the second transaction proposal to the third client device for presentation to the third entity, or to the second client device for presentation to the second entity.

In accordance with further aspects of the disclosure, the cost is a first cost, and the one or more processors further execute the instructions to receive over the network third information identifying a plurality of attributes regarding a transportation resource to be offered for trade, wherein the third information is received from a third client device associated with a third entity that controls the transportation resource. The one or more processors also execute the instructions to automatically calculate a second cost associated with providing the water resource controlled by the first entity to the second entity based on the third information. The one or more processors further execute the instructions to automatically generate the first cost associated with providing the water resource controlled by the first entity to the second entity based on the second cost, the first information, and the second information.

In accordance with still further aspects of the disclosure, the plurality of attributes identified by the first information includes an attribute indicative of a location of the water resource to be offered for trade, an attribute indicative of an availability of the water resource to be offered for trade, and an attribute indicative of a trade condition of the water resource to be offered for trade.

In accordance with other aspects of the disclosure, the plurality of attributes identified by the second information includes an attribute indicative of a location of the water resource need, an attribute indicative of a condition of the water resource need, and an attribute indicative of a trade condition of the water resource need.

Additionally, in accordance with some embodiments, there is provided a non-transitory computer-readable medium that stores instructions. The instructions, when executed by one or more processors, cause the one or more processors to perform a method for facilitating an exchange of a water resource. The method comprises receiving over a network first information identifying a plurality of attributes regarding a water resource to be offered for trade, wherein the first information is received from a first client device associated with a first entity that controls the water resource. The method also comprises receiving over the network second information identifying a plurality of attributes regarding a water resource need, wherein the second information is received from a second client device associated with a second entity that has the water resource need. The method further comprises automatically calculating a cost associated with providing the water resource controlled by the first entity to the second entity based on the first information and the second information. The method still further comprises automatically generating a transaction proposal based on the calculated cost, and providing the transaction proposal to the first client device for presentation to the first entity, or to the second client device for presentation to the second entity.

Before explaining example embodiments consistent with the present disclosure in detail, it is to be understood that the disclosure is not limited in its application to the details of constructions and to the arrangements set forth in the following description or illustrated in the drawings. The disclosure is capable of embodiments in addition to those described and is capable of being practiced and carried out in various ways. Also, it is to be understood that the phraseology and terminology employed herein, as well as in the abstract, are for the purpose of description and should not be regarded as limiting.

It is to be understood that both the foregoing general description and the following detailed description are explanatory only and are not restrictive of the claimed subject matter.

### BRIEF DESCRIPTION OF THE DRAWINGS

The accompanying drawings, which are incorporated in and constitute part of this specification, and together with the description, illustrate and serve to explain the principles of various example embodiments.

FIG. 1 illustrates a flowchart of an example method for facilitating an exchange of a water resource, in accordance with some embodiments.

FIG. 2 illustrates a diagram of an example computing environment, in accordance with some embodiments.

FIG. 3 illustrates a flowchart of another example method for facilitating an exchange of a water resource, in accordance with some embodiments.

FIG. 4 illustrates a flowchart of an example method for receiving information about an available water resource, in accordance with some embodiments.

FIG. 5 illustrates a flowchart of an example method for receiving information about a needed water resource, in accordance with some embodiments.

FIG. 6 illustrates an example screen of a water exchange platform, in accordance with some embodiments.

FIG. 7 illustrates another example screen of a water exchange platform, in accordance with some embodiments.

FIG. 8 illustrates still another example screen of a water exchange platform, in accordance with some embodiments.

FIG. 9 illustrates another example screen of a water exchange platform, in accordance with some embodiments.

FIG. 10 illustrates still another example screen of a water exchange platform, in accordance with some embodiments.

FIG. 11 illustrates a further example screen of a water exchange platform, in accordance with some embodiments.

FIG. 12 illustrates a still further example screen of a water exchange platform, in accordance with some embodiments.

FIG. 13 illustrates another example screen of a water exchange platform, in accordance with some embodiments.

FIG. 14 illustrates still another example screen of a water exchange platform, in accordance with some embodiments.

FIG. 15 illustrates a further example screen of a water exchange platform, in accordance with some embodiments.

FIG. 16 illustrates a still further example screen of a water exchange platform, in accordance with some embodiments.

FIG. 17 illustrates another example screen of a water exchange platform, in accordance with some embodiments.

FIG. 18 illustrates another example screen of a water exchange platform, in accordance with some embodiments.

FIG. 19 illustrates a further example screen of a water exchange platform, in accordance with some embodiments.

FIG. 20 illustrates a still further example screen of a water exchange platform, in accordance with some embodiments.

FIG. 21 illustrates another example screen of a water exchange platform, in accordance with some embodiments.

FIG. 22 illustrates a flowchart of an example method for facilitating an exchange of a disposal resource, in accordance with some embodiments.

FIG. 23 illustrates a diagram of an example computer system, in accordance with some embodiments.

### DETAILED DESCRIPTION OF EXAMPLE EMBODIMENTS

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid unnecessary complication of the disclosed subject matter. In addition, it will be understood that the embodiments provided below are exemplary, and that it is contemplated that there are other systems and methods that are within the scope of the disclosed subject matter.

Embodiments of the present disclosure relate to computerized systems, methods, and media for facilitating an exchange of a water resource. Embodiments of the present disclosure include systems, methods, and media that may receive first information about a water resource that a first entity would like to offer for trade, receive second information about a water resource that a second entity needs, calculate a cost associated with providing the water resource from the first entity to the second entity, generate a transaction proposal based on the cost, and provide the transaction proposal to the first entity or the second entity. The first entity or the second entity may utilize the systems, methods, and media described herein to select the transaction proposal from a listing of transaction proposals, generate an offer to receive or provide the water resource, and generate an order to receive or provide the water resource.

Entities, such as companies or individuals, often have resources at their disposal. Other entities, such as other companies or individuals, may desire these resources. Entities that have resources may trade them with entities that need resources for some sort of compensation, such as monetary compensation. For example, an owner of water resources may sell the water resources to a prospective buyer. Such a transaction benefits the prospective buyer by giving him/her access to the water resources. The transaction also benefits the owner by providing him/her with compensation for his/her loss of control over the water resources.

Resources may not always be efficiently transacted in a manner that best benefits the owner and prospective buyer. For example, in the case of water resources, the needs of a business that uses the water resources may change on a regular basis. For example, an estimate that a certain amount of a water resource is needed for a day may no longer be correct as the day wears on, and a company may find themselves with an excess of a water resource. Moreover, a prospective buyer may be interested in comparing characteristics of a variety of different water resources that are available before making his/her decision on which to purchase.

Embodiments of the present disclosure can address the challenges associated with exchanging water resources. For example, embodiments of the present disclosure provide computerized systems, methods, and media that may facilitate an exchange of a water resource. The computerized systems, methods, and media may facilitate an exchange of a water resource by providing, for example, an online platform for exchanging water resources. In some embodiments, the computerized systems, methods, and media may receive over a network first information about a water resource to be traded, or sold, and second information about a water resource that is needed. The computerized systems, methods, and media provided herein may then automatically calculate a cost associated with providing the water resource to the entity desiring a water resource, automatically generate a transaction proposal based on the cost, and provide the transaction proposal to a client device associated with the entity desiring the water resource. In some embodiments, many transaction proposals may be generated, one for each pairing of a potential seller with a potential buyer. An entity may then peruse a listing of the transaction proposals available, and select a transaction proposal for which he/she would like to generate an offer.

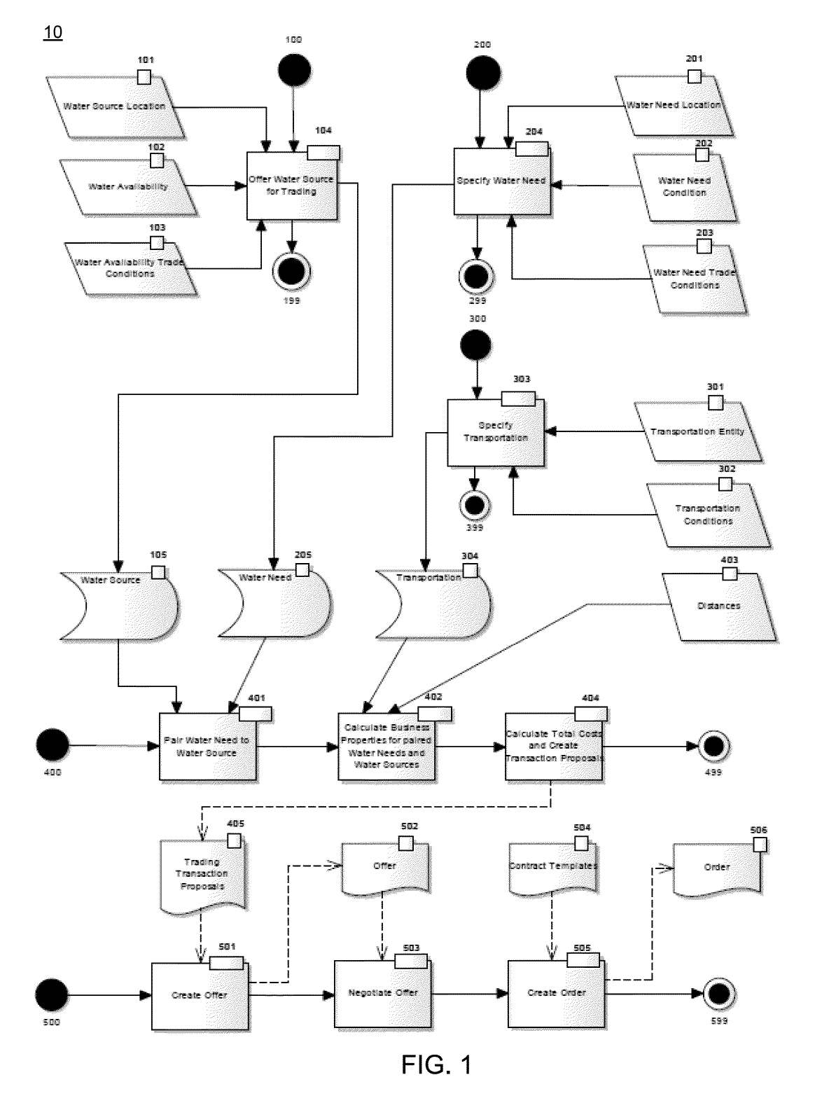

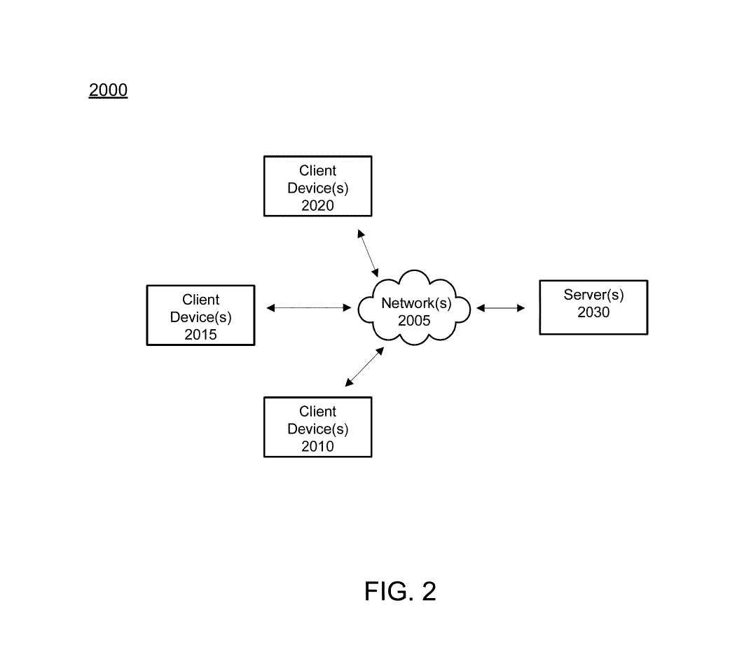

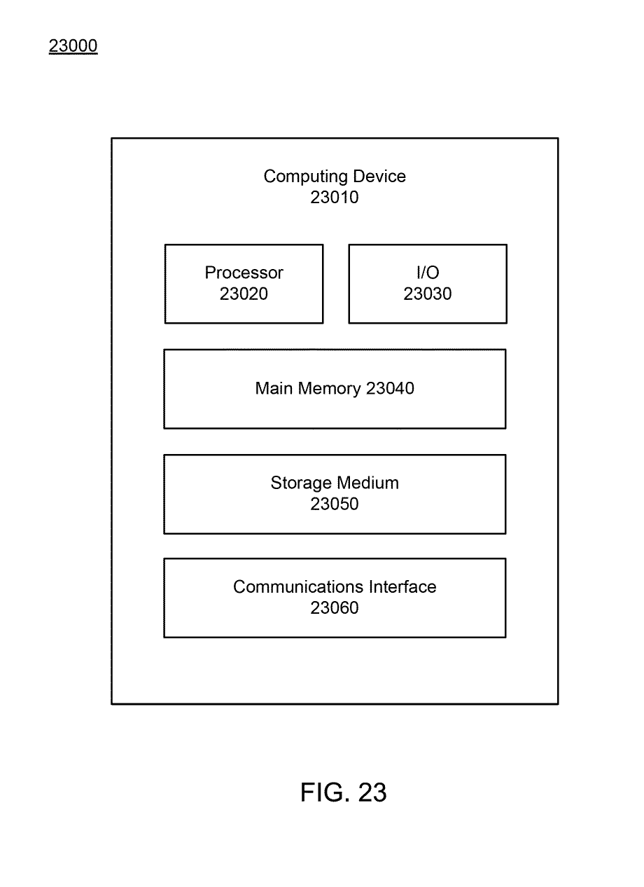

FIG. 1 illustrates an example flowchart of a method 10 that may be used in carrying out embodiments of the present disclosure. Example method 10 may be implemented in a computing environment (see, e.g., FIG. 2) using one or more computer systems (see, e.g., FIG. 23). In some embodiments, method 10 may be performed by one or more servers 2030.

At activation point 100, a user may initiate creation of information about a water resource. The user may be an entity, such as a person or company, that owns or controls a water resource, though the disclosure is not so limited. In some embodiments, the user may be an entity, such as an agent, that assists in the sale or leasing of a water resource, but that may not have any actual financial stake in the water resource. The water resource may be a resource the user would like to make available for sale, trading, and/or leasing, such as through an online water exchange platform. Once a user has initiated creation of information about the water resource, information may be received regarding the water resource. For example, at input 101, water resource location information may be received. Water resource location information may, for example, include a geographical location were the water resource is available. In some embodiments, the water resource location information that is received may be global positioning system (GPS) coordinates for the location. Alternatively, water resource location information may be any other means of identifying a location, such as through use of latitude and longitude information. In some embodiments, the location information for the water resource may be received in response to the user entering the location information. For example, the user may input the location information into a form generated by the water resource exchange platform, and may be received by the platform over a network once the location information has been entered. Alternatively, the location information may be automatically received over a network from a third party provider. In some embodiments, the water resource exchange platform may store information regarding all water resources owned, controlled, and/or managed by the user.

At input 102, water availability information may be received. Water availability information may include one or more attributes about the water resource available at a location entered in input 101. For example, the availability information may include any combination of one or more attributes of the water resource, such as a volume of water available, a date when the water volume is available, a type of a source of the water resource, a type of the water in the water resource, a sub type of the water in the water resource, a quality metric of the water in the water resource, and a quality report of the water in the water resource. A volume of the water available may be an exact volume of water available, a minimum volume of water on offer, a maximum value of water on offer, a range of values of water on offer, or any other volume of water, and may be specified in units of volume. A date when the water is available may be a specific day, time, or date range on which the water volume is available. A type of a source of the water resource may, for example, be stock when the specified volume is available once or on specific dates, flow when the specified volume is available on a regular (e.g., daily) basis, or any other type of a source that may be specified. A type of the water in the water resource may include fresh water, produced water, or any other type of water. A sub type of the water in the water resource may include types of fresh water, types of produced water, or sub types of any other type of water. A water quality metric may include a value for acidity or alkalinity of the water, such as a pH number, a value for salinity of the water, a value for total dissolved solids (TDS) in the water, or a value for any other characteristic indicative of water quality. A quality report of the water may include information issued by a third party, such as a document confirming water quality metrics from a government organization.

At input 103, one or more water availability trade conditions may be received. A water availability trade condition may include trading and/or business properties for attributes associated with a water resource, such as attributes entered at input 101 and/or 102. A water availability trade condition may include, for example, any combination of one or more of a price, a type of trade, a business transaction negotiation method, and any other trade property. A price may include, for example, a price per volume unit of the water, such as the price per volume unit in which water availability was specified for the water resource at input 102. A type of trade may include, for example, whether the water resource is for sale, where the buyer pays for the water, whether the water resource is for disposal, where the seller pays for the water, or any other custom pricing method that may be specified by a user. A business transaction method may include, for example, a non-negotiable offer, an auction, such as a reverse auction, a negotiation between a buyer and seller, or any other known business transaction method. Another trade property may include a minimum order volume, a maximum order volume, or any other trade property entered by the user. In some embodiments, if the water is for disposal, the entity with the water for disposal (e.g., wastewater) may indicate that the entity would pay another entity to reuse the water. For example, this indication may be included as a type of trade attribute. Offering to pay someone to reuse the wastewater may allow the entity with the wastewater to avoid disposal costs, and allow the entity reusing the wastewater to avoid purchase costs.

After input at one or more of inputs 101, 102, 103 is received, at step 104, the input may be used to generate an offer of a water resource for trading. For example, an online water resource exchange platform may generate a record containing information based on values entered in inputs 101, 102, 103, and use the record to place an offer for the water resource into the water exchange platform. At step 104, the offer may be generated by combining one or more of the attributes entered in inputs 101, 102, 103 for use in the system to solicit prospective buyers. Activation input 199 in method 10 may indicate that an offer has been generated.

Once the offer has been generated, at step 105, the information regarding the water resource entered at inputs 101, 102, 103 may be stored in a storage device, such as a database. This information may then be used for trading the water resource.

At activation point 200, a user, which may be the same user at activation point 100, or a different user, may initiate creation of information about a water resource the user needs and/or would like to buy or lease. In some embodiments, the user may be an entity, such as a person or company, that desires a water resource. In some embodiments, the user may be an entity, such as an agent, that assists in the purchase or leasing of a water resource, but that may not have any actual financial stake in the desired water resource. Once a user has initiated creation of information about the desired water resource, information may be received regarding the desired resource. For example, at input 201, a location of the water resource need may be received. A location of a water resource need may, for example, include a geographical location where the water resource is needed. In some embodiments, the water resource need location that is received may be GPS coordinates for the location. Alternatively, water resource location information may be any other means of identifying a location, such as through use of latitude and longitude information. In some embodiments, the location information for the water resource need may be received in response to the user entering the location information. For example, the user may input the location information into a form generated by the water resource exchange platform, and may be received by the platform over a network once the location information has been entered. Alternatively, the location information may be automatically received over a network from a third party provider, such as a third party provider storing water demand data. In some embodiments, the water resource exchange platform may store information regarding all water resources desired by a user.

At input 202, information about a water resource need condition may be received. A water resource need condition may include one or more attributes about the water resource need entered at input 201. For example, the water resource need condition may include any combination of one or more attributes of the water resource needed, such as a volume of water needed, a date on which the water resource is needed, a type of water needed, a sub type of water needed, a quality metric of the water needed, a quality report of the water needed, and an ability to allow a third party to test the water resource. A volume of the water available may be any volume of water desired, and may include a minimum value, a maximum value, a range of values, a specific volume of water, or any other volume of water. A date on which the water resource is needed may include a specific day, time, or date range on which the water is desired. A type of water needed may include fresh water, produced water, wastewater, or any other type of water. A sub type of water needed may include a type of fresh water, a type of produced water, or a sub type of any other type of water. A water quality metric may include a value for acidity or alkalinity of the water desired, such as a pH number, a value for salinity of the water, a value for TDS in the water, or any other characteristic indicative of water quality. A quality report of the water desired may include a desire for information issued by a third party, such as a document confirming water quality metrics from a government organization. An ability to allow a third party to test the water resource may indicate that the prospective buyer wishes to have the water tested by a third party as part of a purchase contract.

At input 203, one or more water need trade conditions may be received. A water need trade condition may include trading and/or business properties for attributes associated with a water resource desired by a user, such as attributes entered at input 201 and/or 202. A water need trade condition may include, for example, any combination of one or more attributes, such as a price, a type of trade, a business transaction negotiation method, or any other trade property. A price may include, for example, a price per unit volume of the water that the user is willing to pay, such as a minimum, maximum, or range of prices specified per volume units in which a water need condition was specified at 202 for the water resource needed. A type of trade may include, for example, whether the user wishes to buy water (e.g., user pays the price), whether the user wishes to dispose of water (e.g., seller pays the price), or any other custom pricing method input by the user or a seller of a water resource. A business transaction negotiation method may include, for example, a non-negotiable offer, an auction, such as a reverse auction, pricing limits such as auction bid maximums and minimums, an absolute price for an offer, or any other known business transaction method. Another trade property may include a minimum order volume, a maximum order volume, or any other trade property entered by the user. In some embodiments, if the user will reuse water (e.g., reuse wastewater), the user may indicate this option, such as with a type of trade attribute. Offering to reuse wastewater may allow an entity with the wastewater to avoid disposal costs, and allow the entity reusing the wastewater to avoid purchase costs. If a user is willing to reuse wastewater, the user may indicate the price or price range at which the user is willing to be paid to reuse the water as a water need trade condition.

After input at one or more of inputs 201, 202, 203 is received, at step 204, the input may be used to generate an offer of a water resource need for trading. For example, an online water exchange platform may generate a record containing information based on values entered in inputs 201, 202, 203, and use the record to place an offer for the water resource need into the water exchange platform. At step 204, the water need offer may be generated by combining one or more of the attributes entered in inputs 201, 202, 203 for use in the system to solicit prospective sellers. Activation input 299 in method 10 may indicate that an offer for a water need has been generated.

Once the offer for the water need has been generated, at step 205, the information regarding the water resource need entered at inputs 201, 202, 203 may be stored in a storage device, such as a database. This information may then be used for trading the water resource need.

At activation point 300, a user may initiate creation of information about a transportation resource. The user may be the same user as at activation point 100 and/or 200, or may be a different user. The user may be an entity, such as a person or company, that owns or controls a transportation resource, though the disclosure is not so limited. In some embodiments, the user may be an entity, such as an agent, that assist in the sale or leasing of a transportation resource, but that may not have any actual financial stake in the transportation resource. The transportation resource may be a resource the user would like to make available for sale, trading, and/or leasing, such as through an online water exchange platform. Once a user has initiated creation of information about the transportation resource, information may be received regarding the transportation resource. For example, at input 301, transportation entity information may be received. Transportation entity information may include information identifying a transportation entity, such as a third party provider of transportation services, an internal service of a user, or any other entity that provides water tracking services. The transportation entity information may include one or more attributes, such as a name of the transportation entity, a location of the transportation entity, or other information about the transportation entity. In some embodiments, the transportation entity information may be received in response to the user entering the transportation entity information. For example, the user may input the transportation entity information into a form generated by the water resource exchange platform, and the information may be received by the platform over a network once the transportation entity information has been entered. Alternatively, the transportation entity information may be automatically received over a network from a third party provider. In some embodiments, the water resource exchange platform may store information regarding all transportation entities owned, controlled, and/or managed by the user.

At input 302, information regarding one or more transportation conditions may be received. Transportation condition information may include one or more attributes about a transportation entity entered at input 301. For example, transportation conditions may include or more conditions for transporting items between two locations. The conditions may include one or more attributes, such as capacity per transportation method (e.g., truck, pipeline), loading time, loading cost, price per time (e.g., hour) of transportation, price per unit of distance transportation, price per volume of transportation, or any other attribute pertaining to a particular transportation entity.

After input at one or more of inputs 301, 302 is received, at step 303, the input may be used to generate an offer of a transportation resource for trading. For example, an online water resource exchange platform may generate a record containing information based on values entered in inputs 301, 302, and use the record to place an offer for the transportation resource into the water exchange platform. At step 303, the offer may be generated by combining one or more of the attributes entered in inputs 301, 302 for use in the system to solicit prospective buyers. Activation input 399 in method 10 may indicate than an offer has been generated.

Once the offer of a transportation resource has been generated, at step 304, the information regarding the transportation resource entered at inputs 301, 302 may be stored in a storage device, such as a database. This information may then be used for trading the transportation resource.

At activation point 400, a user may initiate pairing a water resource offer that was stored in step 105 with a water resource need offer that was stored in step 205. The user may be a user who controls a water resource entered into the water exchange platform, a user who needs a water resource entered into the water exchange platform, or any other user. Once the user has initiated the pairing, information may be gathered about the water resource offers and water resource needs entered in the platform. For example, at step 401, one or more of the water resource records stored in step 105 (e.g., by inputs 101, 102, 103 combined in step 104) may be matched with one or more water resource need records stored in step 205 (e.g., by inputs 201, 202, 203 combined in step 204). The matching may include comparing and/or evaluating permutations of related attributes, such as volumes, prices, water types, water quality types, and other attribute types. A list of suitable matches may then be output.

At step 402, distances between locations of available water resources stored in step 105 and locations of water resources needed stored in step 205 may be calculated, as well as the associated transportation costs based on attributes entered for transportation entities and stored in step 304. The calculated cost may depend on a distance, a number of trucks needed, a time needed for transport, a loading cost, an unloading cost, a cost of a pipeline usage, or other costs associated with transportation of items. For example, the calculated cost may depend on a total road distance involved, a number of trucks required to transport the desired volume, a time needed to transport a certain volume, or any other cost associated with transportation. The distances involved may be calculated at input 403. For example, the distances calculated may be the distances between locations of available water resources and locations of water resource needs. Distance calculations may be performed by the water resource exchange platform, or by a third party application via an Application Programming Interface (API). The input for the calculation may consist of GPS coordinates for locations of the available water resources and the water resource needs. The output of the calculation may be an aerial, road, pipeline, or other distance relevant for a transportation cost calculation.

At step 404, outputs of steps 401 and 402 may be combined to create one or more trading transaction proposals. For example, a trading transaction proposal may be generated based on a combination of one or more attributes, such as a price, a time-to-availability, a water need condition, a transportation cost, a transportation distance, a frequency of water resource availability, a regularity of water resource availability, or any other attribute, including any of the other attributes discussed above with reference to inputs 101, 102, 103, 201, 202 203, 301, or 302. In some embodiments, attributes stored in the system can be combined with new user search criteria. Trading transaction proposals may be generated based on lowest prices, a minimum or maximum price threshold, a shortest time-to-availability, criteria that gives the greatest number of matches, lowest transportation costs, a minimum or maximum transportation cost, a minimum or maximum transportation distance, or any other type of criteria or attribute. Once the trading transaction proposals have been generated, they can be provided to the user in a list in step 405. Activation input 499 in method 10 may indicate that the user has received the trading transaction proposals.

At activation point 500, a user may initiate creation of an offer for a water resource, or to fulfill a water resource need. The user may be an entity, such as a person or company. The user may be the same user as one of the users previously mentioned, or may be a different user. Based on user input, a request to initiate a business transaction is received. This may be received, for example, based on the user selecting one or more of the trading transaction proposals from the list of trading transaction proposals. Once the user has selected one or more trading transaction proposals, the user may generate one or more offers for the trading transaction proposals in step 501. An offer may be generated by receiving various input information from the user, such as a pickup date, a volume, an on-site quality report requirement, price negotiation options, or any other attributes a user may wish to incorporate into the offer. The offer may be received, for example, when a user inputs the attributes into a form generated by the water exchange platform. Once the user has generated the offer, it is delivered to the other party to the transaction in step 502.

At step 503, the parties involved in the offer generated at step 501 may negotiate the attributes, or terms and conditions, incorporated into the offer. This negotiation may include, for example, negotiating over price, providing auctioning services between offerors or offerees, negotiating over pickup dates or delivery dates, negotiating over volumes to be delivered, negotiating over transportation method involved, or any other attribute, term, or condition that could be included in the offer.

At step 504, a template for a contract governing the terms of the sale and purchase of the water resources may be generated. For example, once the parties are in agreement as a result of step 503, a contract template including the agreed upon attributes, terms, and conditions may be generated in step 504. Fields of the contract template may be automatically populated based on the result of the negotiation in step 503, as well as attributes carried over from prior steps, such as steps 405, 502.

At step 505, if the negotiating parties agree to the terms, attributes, and conditions incorporated into the contract, an order is generated in accordance with the final contract. The order 506 may be based on a final contract including the terms, conditions, and attributes agreed upon between the negotiating parties, and may have been automatically populated with attributes from prior steps, and automatically generated in step 504. The contract may include fields for signatures and dates for accepting the contract terms and conditions, final agreed upon prices, final delivery conditions, other conditions that must be met by one or both parties, agreed upon transportation method, information from one or more of inputs 101, 102, 103, 201, 202, 203, 301, 302, 303, and other terms, conditions, and attributes negotiated in step 503. The contract may also include terms and conditions associated with the service provider of the online water resource exchange platform. Activation point 599 in method 10 may indicate that the order has been generated.

FIG. 2 is a block diagram of an example computing environment 2000 for implementing embodiments of the present disclosure. The arrangement and number of components in computing environment 2000 is provided for purposes of illustration. Additional arrangements, number of components, and other modifications may be made, consistent with the present disclosure.

As shown in FIG. 2, computing environment 2000 may include one or more client devices 2010, 2015, 2020, networks 2005, and servers 2030 Client devices 2010, 2015, 2020 may be coupled to each other, and to server(s) 2030 by one or more networks 2005.

By way of example, a client device 2010, 2015, 2020 could be a personal computer, desktop computer, laptop computer, server, mobile computer, mobile phone, smart phone, tablet computer, netbook, electronic reader, personal digital assistant (PDA), wearable computer, smart watch, gaming device, set-top box, television, personal organizer, portable electronic device, smart appliance, navigation device, and/or other type of computing device. In some embodiments, a client device 2010, 2015, 2020 may be implemented with hardware devices and/or software applications running thereon. A client device 2010, 2015, 2020 may communicate with one or more computer systems (e.g., server(s) 2030) over one or more networks 2005. A client device 2010, 2015, 2020 may store browser software that enables a client device 2010, 2015, 2020 to access resources on a network, such as the Internet. In some embodiments, one or more of client device(s) 2010, 2015, 2020 may be implemented using a computer system, such as computer system 2300 of FIG. 23.

Computing environment 2000 may include one or more networks 2005. In one embodiment, network(s) 2005 may be one or more local networks (e.g., personal area networks (PANs), local area networks (LANs), metropolitan area networks (MANs)), though the disclosure is not so limited. Network(s) 2005 may connect client device(s) 2010, 2015, 2020 with one or more servers 2030, and/or other client devices 2010, 2015, 2020. Network(s) 2005 may include one or more PANs, LANs, MANs, wide area networks (WANs), or any combination of these networks. Network(s) 2005 may include a combination of a variety of different network types, including Ethernet, intranet, twisted-pair, coaxial cable, fiber optic, cellular, satellite, IEEE 802.11, WiFi, terrestrial, Internet, and/or other types of wired or wireless networks.

Client device(s) 2010, 2015, 2020 may be configured to communicate with one or more servers 2030. A server 2030 may be a server 2030 may be a standalone computer system or apparatus, or it may be part of a larger system. For example, server(s) 2030 may represent distributed servers that are remotely located and communicate over a communications network, such as a LAN. Server(s) 2030 may include one or more back-end servers for carrying out one or more aspects of the present disclosure. Server(s) may include one or more computing systems (e.g., computer system(s) 23000), such as one or more servers, web servers, application servers, database servers, personal computers, laptop computers, or any other type of computing device. In some embodiments, server(s) 2030 may be configured to carry out embodiments disclosed herein, such as methods 10, 3000, 4000, and 5000. Server(s) 2030 may function to provide a water resource exchange platform, such as an online water resource exchange platform. Consistent with the discussion above with reference to method 10, server(s) 2030 may store user information, available water resource information, information about water resource needs, attributes and/or characteristics regarding water resources, attributes and/or characteristics of user desires with regard to available water resource sales and/or purchases, and/or any other information that may be utilized in carrying out embodiments consistent with the present disclosure. Server(s) 2030 may calculate distances between locations where water resources are available and where they are needed, may calculate costs, such as costs of transporting water resources, and/or may pair available water resources with water resource needs. Server(s) 2030 may generate offers and contracts, facilitate negotiations between prospective buyers and sellers, generate orders, and/or otherwise facilitate the trading of water resources via an online water resource exchange platform.

A server 2030 may be implemented as a server system comprising a plurality of servers, or a server farm comprising a load balancing system and a plurality of servers. A server 2030 may be any type of known server, and may exist as software, hardware, or a combination of software and hardware. In some embodiments, one or more server(s) 2030 may be implemented using a computer system, such as computer system 2300 of FIG. 23.

Although computing environment 2000 of FIG. 2 illustrates three different client devices 2010, 2015, 2020, the disclosure is not so limited. Any number of client devices may be included in computing environment 2000. Three different client devices 2010, 2015, 2020 are illustrated in FIG. 2 to illustrate an example where three different client devices are utilized, one by an entity with a water resource need, one by an entity with a water resource available for sale or lease, and one by an entity with a transportation resource for sale or lease. However, the disclosure is not so limited. Any number of different users with water resource needs, water resources to sell, and/or transportation resources to sell may utilize the water resource exchange platform through any number of client devices 2010, 2015, 2020.

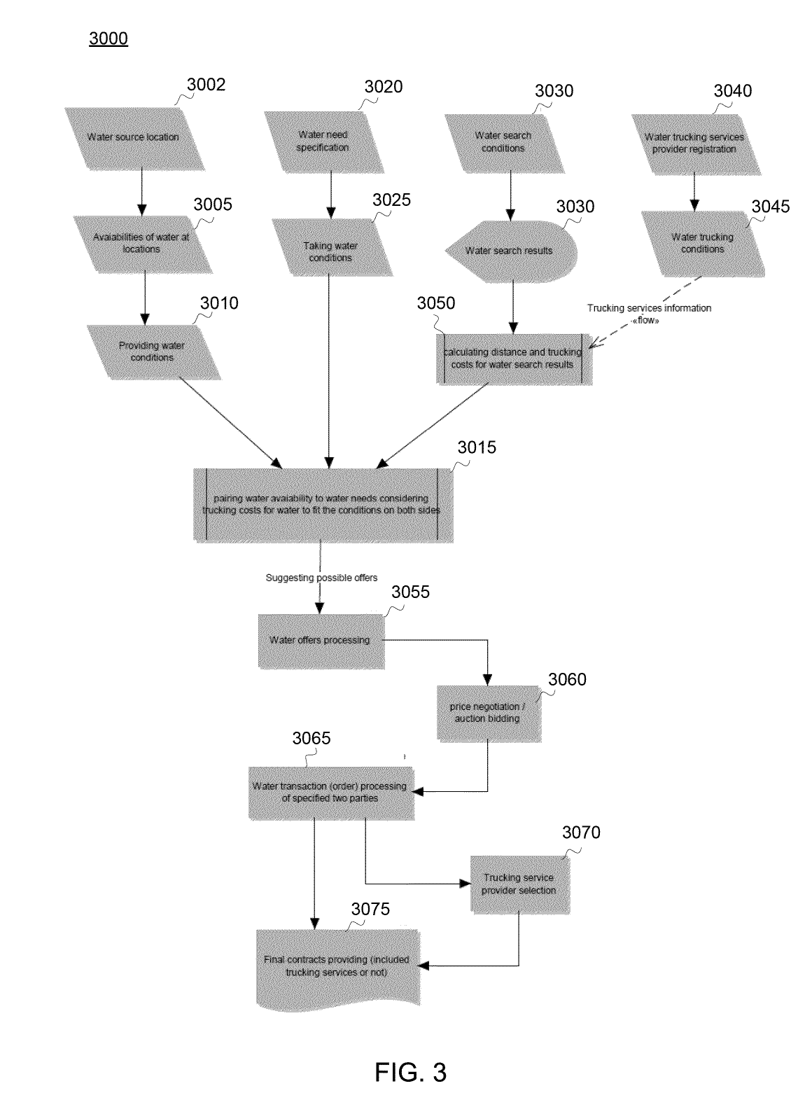

FIG. 3 illustrates a flowchart of an example method 3000, consistent with embodiments of the present disclosure. Example method 3000 may be implemented in a computing environment (see, e.g., FIG. 3) using one or more computer systems (see, e.g., FIG. 23). In some embodiments, method 3000 may be performed by one or more servers 2030.

In step 3002, a location of a water resource may be received. This may be carried out, for example, in any of the ways discussed with respect to input 101 of FIG. 1. In step 3005, an availability of the water resource may be received. This may be carried out, for example, in any of the ways discussed with respect to input 102 of FIG. 1. In step 3010, one or more conditions of trading the water resource may be received. This may be carried out, for example, in any of the ways discussed with respect to input 103 of FIG. 1.

In step 3020, attributes for a water resource need may be received. This may be carried out, for example, in any of the ways discussed with respect to inputs 201, 202 of FIG. 1. In step 3025, one or more conditions of trading the water resource may be received. This may be carried out, for example, in any of the ways discussed with respect to input 203 of FIG. 1.

In step 3030, a user may enter search conditions for identifying offers of available water resources and/or water resource needs. In step 3040, information regarding a transportation resource that is available may be received. This may be carried out, for example, in any of the ways discussed with respect to input 301 of FIG. 1. In step 3045, information regarding attributes associated with the transportation resource may be received. In step 3050, distances between locations where water resources are available and where water resources are needed may be calculated, and transportation costs may be calculated based on the locations and the distances.

In step 3015, records for available water resources may be paired with records for water resource needs. For example, records may be paired based on attributes between the records matching, or being consistent, with one another. Based on this pairing, a list of trading transaction proposals may be provided to a user. The list of trading transaction proposals may be provided, for example, in any of the ways discussed with respect to step 405 of FIG. 1. The user may then select one or more of the trading transaction proposals to create an offer for the water resource in step 3055. The offer for the water resource may be generated in any of the ways discussed with respect to step 501 of FIG. 1. The entity controlling the water resource involved in the offer may then negotiate the terms of the offer with the entity that desires the water resource. This may be carried out in any of the ways discussed with respect to step 503 of FIG. 1. For example, various tools, such as online auction tools, may be provided by the online water resource exchange platform to facilitate negotiation of offers. Once the parties to the offer have agreed to terms, conditions, and attributes related to the sale and/or purchase of the water resource, an order may be generated in step 3065. This may be carried out in any of the ways discussed with respect to step 505 of FIG. 1. In step 3070, a trucking service may be selected by one, or both, of the parties to the order. In step 3075, the contract may be finalized and the order placed.

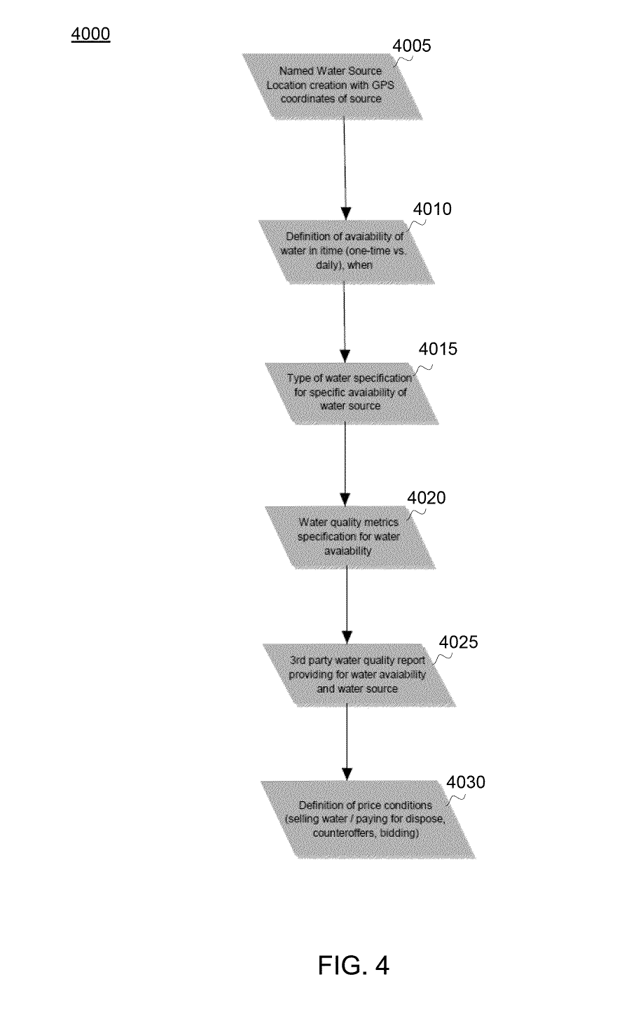

FIG. 4 illustrates a flowchart of an example method 4000, consistent with embodiments of the present disclosure. Example method 4000 may be implemented in a computing environment (see, e.g., FIG. 3) using one or more computer systems (see, e.g., FIG. 23). In some embodiments, method 4000 may be performed by one or more servers 2030. In some embodiments, method 4000 may represent steps carried out when receiving information regarding a water resource that is available for offer from an entity, such as a user, that controls the water resource.

In step 4005, information about a water source, such as a name and/or location of the water resource, may be received from the user. This may be carried out in any of the ways discussed with respect to step 101 of FIG. 1. In step 4010, information including attributes describing the availability of the water resource may be received. This may be carried out in any of the ways discussed with respect to step 102 of FIG. 2. In step 4015, the user may specify one or more types of water for the water resource. For example, the user may indicate that the water is fresh water, saltwater, waste water, produced water, or any other type of water. In step 4020, the user may specify one or more quality metrics for the water resource. For example, the user may indicate a pH level of the water, a salinity of the water, or any other attribute relating to the quality of the water. In step 4025, the user may specify one or more water quality reports associated with the water resource, such as a document issued by a government agency regarding the water's quality. In step 4030, the user may specify trading conditions for the water resource, such as a trade type, such as water for sales (e.g., buyer pays price for water) or water for disposal (e.g., seller pays price for water). The user may also specify pricing conditions (e.g., price per volume unit), business transaction negotiation methods (e.g., non-negotiable offer, reverse auction, negotiation allowed), or other trade properties (e.g., minimum or maximum order volumes). Step 4030 may be carried out in any of the ways discussed with respect to step 103 of FIG. 1.

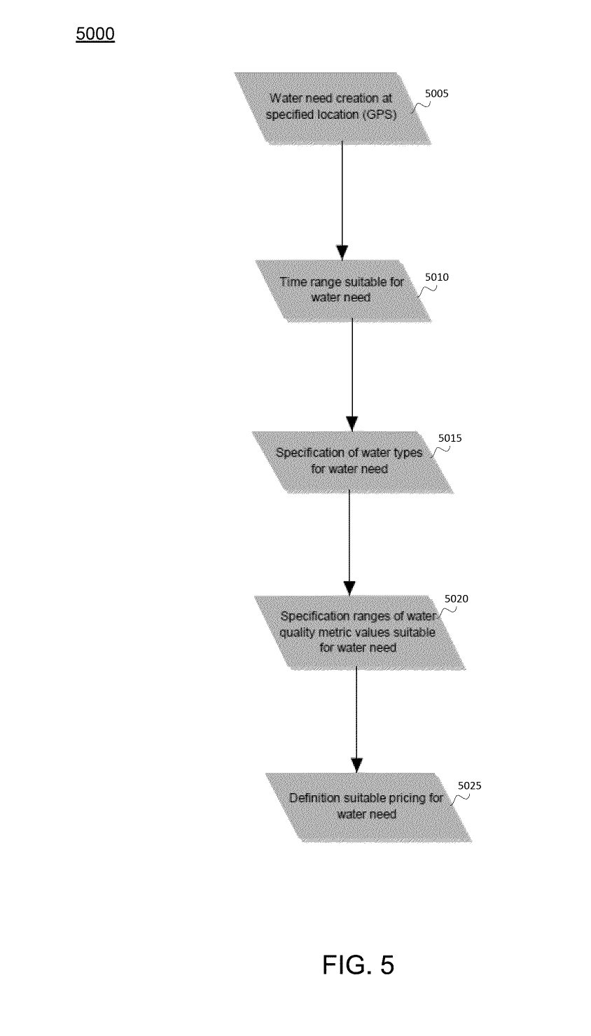

FIG. 5 illustrates a flowchart of an example method 5000, consistent with embodiments of the present disclosure. Example method 5000 may be implemented in a computing environment (see, e.g., FIG. 3) using one or more computer systems (see, e.g., FIG. 23). In some embodiments, method 5000 may be performed by one or more servers 2030. In some embodiments, method 5000 may represent steps carried out when receiving information regarding a water resource that is needed by an entity, such as a user, that desires the water resource.

In step 5005, information may be received from the user regarding the water resource need. Step 5005 may be carried out in any of the ways discussed with respect to step 201 of FIG. 1. For example, information regarding a location of the water resource need, such as GPS coordinates of the location of the water resource need, may be received). In step 5010, a date for which the user needs the water resource may be received. The date may be, for example, a day, time, or date range. In step 5015, information about one or more types of water needed may be received. For example, the user may indicate that the water desired should be fresh water, saltwater, waste water, produced water, or any other type of water. In step 5020, information about one or more types of water quality metrics may be received. For example, the user may indicate a pH level of the water, a salinity of the water, or any other attribute relating to the quality of the water the user desires. In step 5025, information about one or more pricing conditions for the needed water resource may be received. For example, the user may specify maximum and/or minimum prices the user is willing to pay for the water resource.

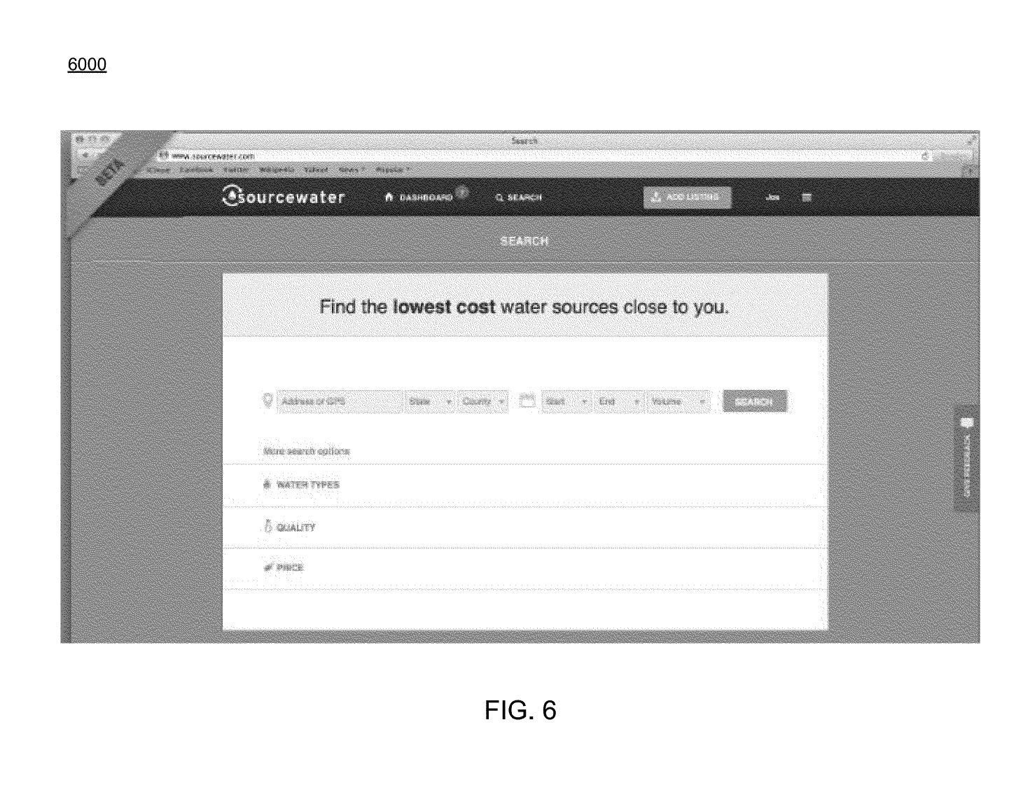

FIGS. 6-21 illustrate example screens of an online water resource exchange platform, consistent with the embodiments presented herein. The screens illustrated in FIGS. 6-21 are examples of what may be displayed to users utilizing the online water resource exchange platform. For example, screens illustrated in FIGS. 6-21 may be examples of screens that server(s) 2030 may provide users as server(s) perform one or more of methods 10, 3000, 4000, or 5000. In some embodiments, the screens illustrated in FIGS. 6-21 may be webpages hosted by server(s) 2030, and may be displayed in a web browser of a client device 2010, 2015, 2020

FIG. 6 illustrates an example screen 6000 of an online water resource exchange platform, consistent with the embodiments presented herein. As illustrated in screen 6000, the platform may provide fields, and a user may enter information into the fields to search for lowest priced water resources that are available close to the user. For example, screen 6000 provides location fields into which the user can enter his location, either with an address or with GPS coordinates. Screen 6000 also provides date fields in to which the user can enter a date range for which the user desires the water resources. Screen 6000 also includes a volume field into which the user can specify the volume of water resources in which he/she is interested. Screen 6000 also includes options that allow the user to specify a type of water in which the user is interested, a quality of water in which the user is interested, and a price the user is willing to pay for the water resource. Screen 6000 further includes a logo of the service provider providing the online water resource exchange platform, a link to provide feedback to the service provider, and a username indicating the user (e.g., “Joe” in this case) who is logged into the platform.

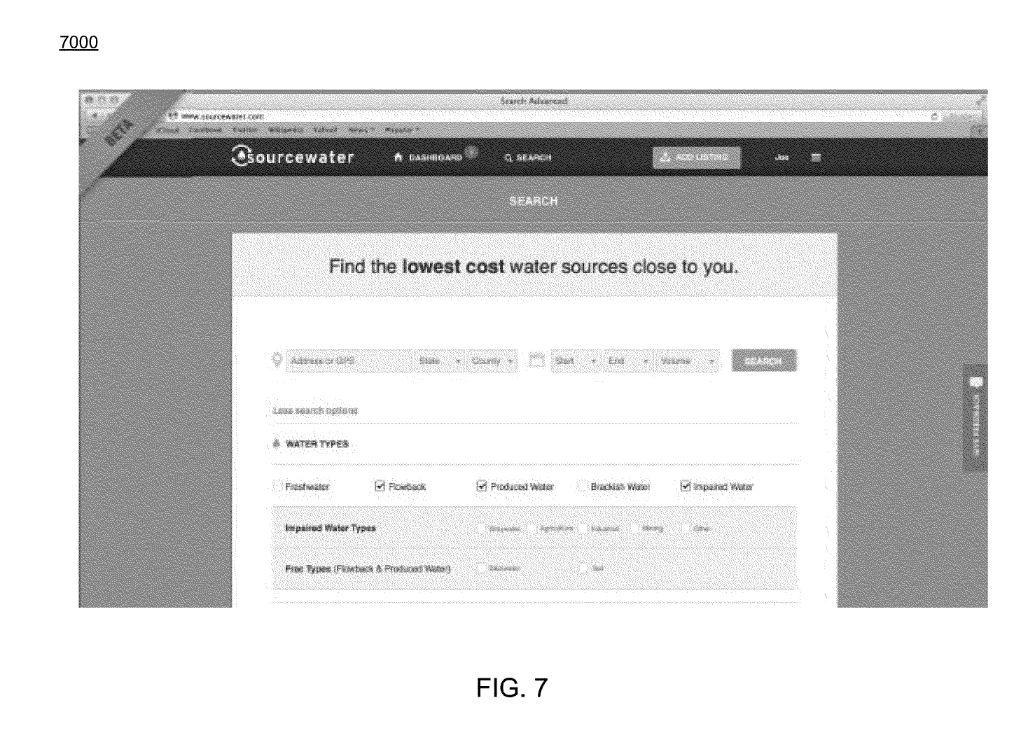

FIG. 7 illustrates another example screen 7000 of an online water exchange platform, consistent with the embodiments presented herein. As illustrated in screen 7000, when a user expands the water types options, the user may select one or more types of water in which the user is interested, such as fresh water, flowback water, produced water, brackish water, and/or impaired water. As also illustrated in screen 7000, after selecting a water type, the user may be given the option to select one or more sub types of water. For example, in screen 7000, the user has selected impaired water as a water type, and is given sub type options of greywater, agriculture, industrial, mining, or other. As also shown in screen 7000, the user has selected flowback and produced water as water types, and is given sub type options of slickwater and gel.

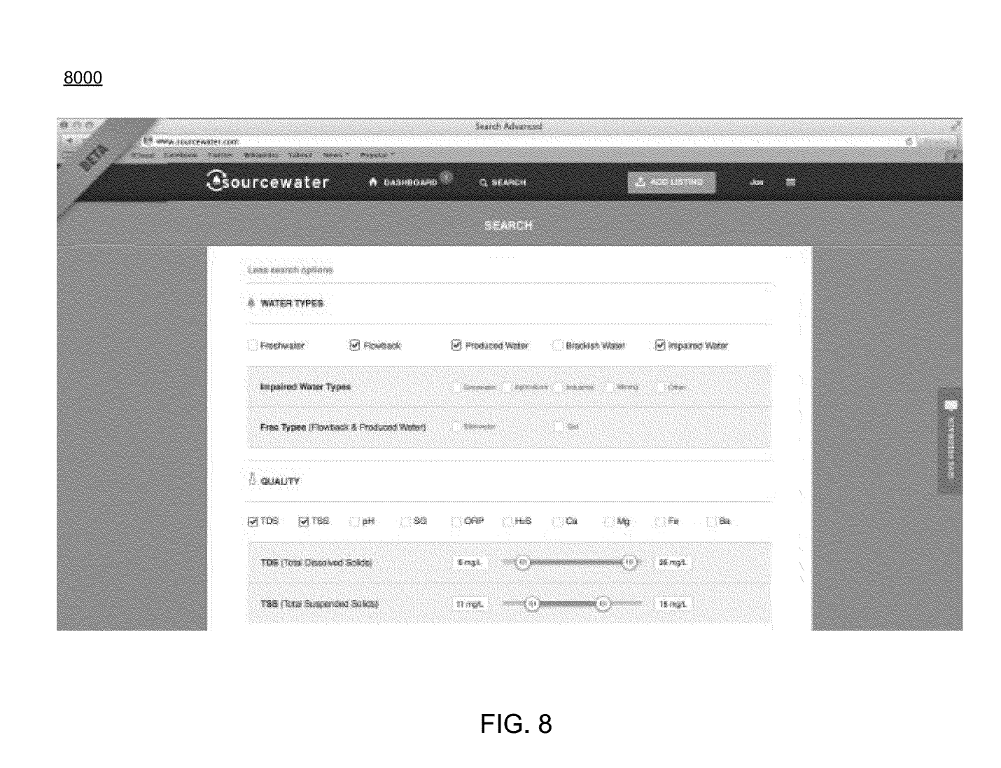

FIG. 8 illustrates another example screen 8000 of an online water exchange platform, consistent with the embodiments presented herein. As illustrated in screen 8000, when a user expands the water quality options, the user may select one or more values for water quality factors in which the user is interested. For example, in screen 8000, the user has selected TDS, and is given a tool to specify a range of the amount of TDS in which he is interested (e.g., between 5 mg/L and 25 mg/L). As also illustrated in screen 8000, the user has selected total suspended solids (TSS), and is given a tool to specify a range of the amount of TSS in which he is interested (e.g., between 11 mg/L and 15 mg/L).

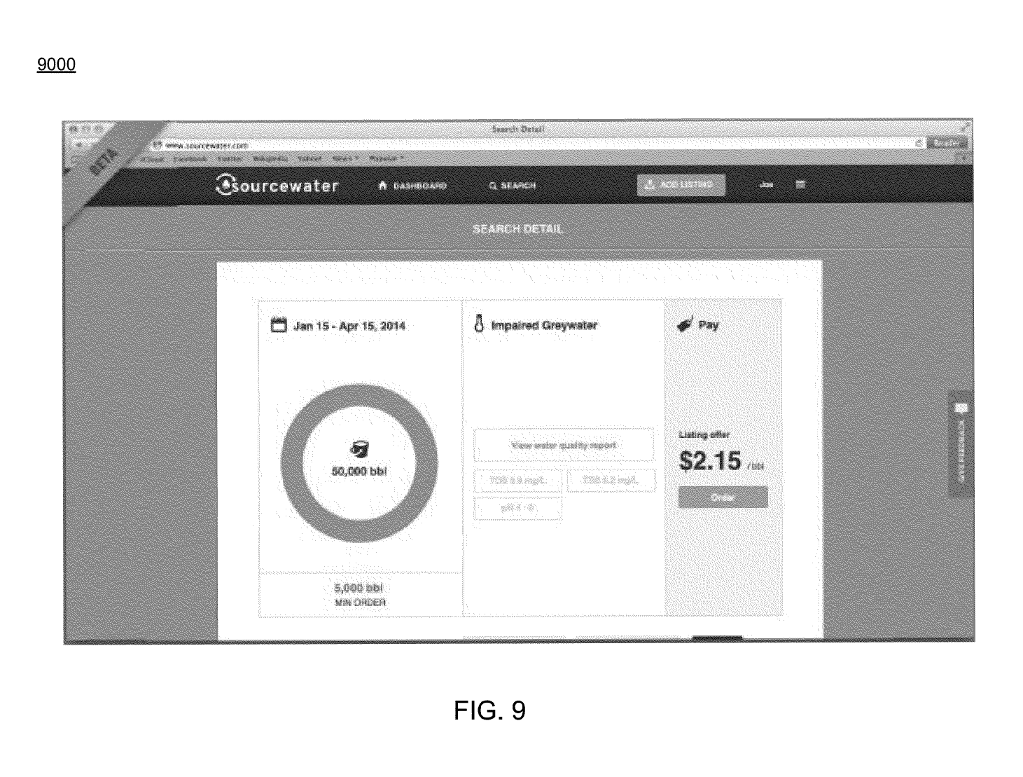

FIG. 9 illustrates another example screen 9000 of an online water exchange platform, consistent with the embodiments presented herein. As illustrated in screen 9000, in response to the user's search, the user may get details of a water resource that is available for purchase between Jan. 15 and Apr. 15, 2014. As also shown in screen 9000, the details may list a volume of water that is available (e.g., 50,000 barrels (bbl)) and a minimum volume of water that must be purchased (e.g., 5,000 bbl). Screen 9000 also illustrates the type of water that is available, provides a link from which the user can access a water quality report, lists TDS and TSS values for the water, and lists a pH level for the water. Screen 9000 also lists the price per unit of the water.

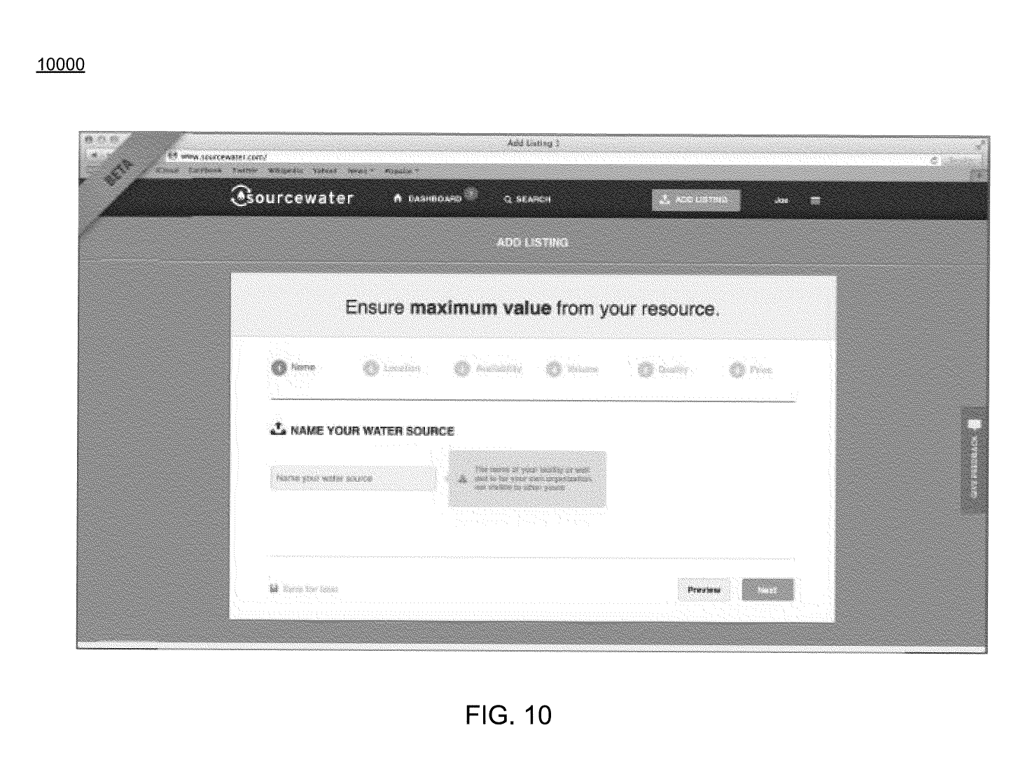

FIG. 10 illustrates another example screen 10000 of an online water exchange platform, consistent with the embodiments presented herein. As illustrated in screen 10000, a user with a water resource available can enter a name for the user's water resource. The user may then click a button (e.g., “Next”) to proceed to the next screen (e.g., screen 11000).

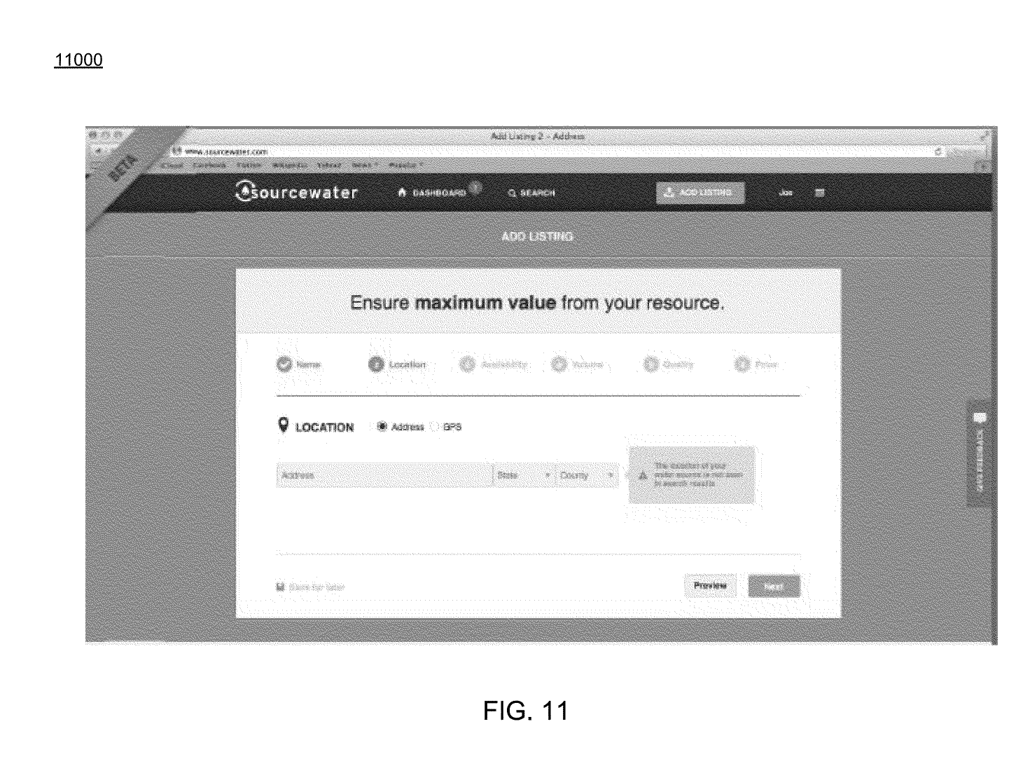

FIG. 11 illustrates another example screen 11000 of an online water exchange platform, consistent with the embodiments presented herein. As illustrated in screen 11000, a user with a water resource available may enter a location of the water resource. For example, the user may enter an address or GPS coordinates corresponding to the location of the water resource. The user may then select a button (e.g., “Next”) to proceed to the next screen (e.g., screen 12000).

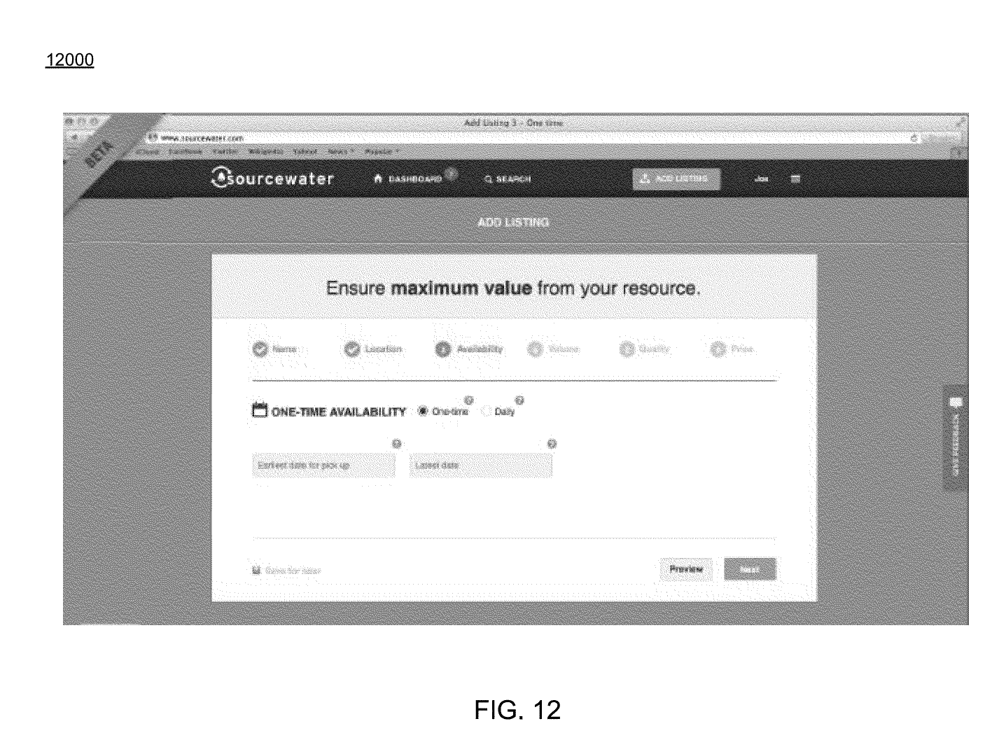

FIG. 12 illustrates another example screen 12000 of an online water exchange platform, consistent with the embodiments presented herein. As illustrated in screen 12000, a user with a water resource available may enter attributes regarding the availability of the water resource. For example, in screen 12000, the user may select whether the water resource is only available once, or whether it is available on a regular basis (e.g., daily). The user may also enter pickup attributes, such as an earliest date the water resource will be available for pickup, and a latest date the water resource will be available for pickup. The user may then select a button (e.g., “Next”) to proceed to the next screen (e.g., screen 13000).

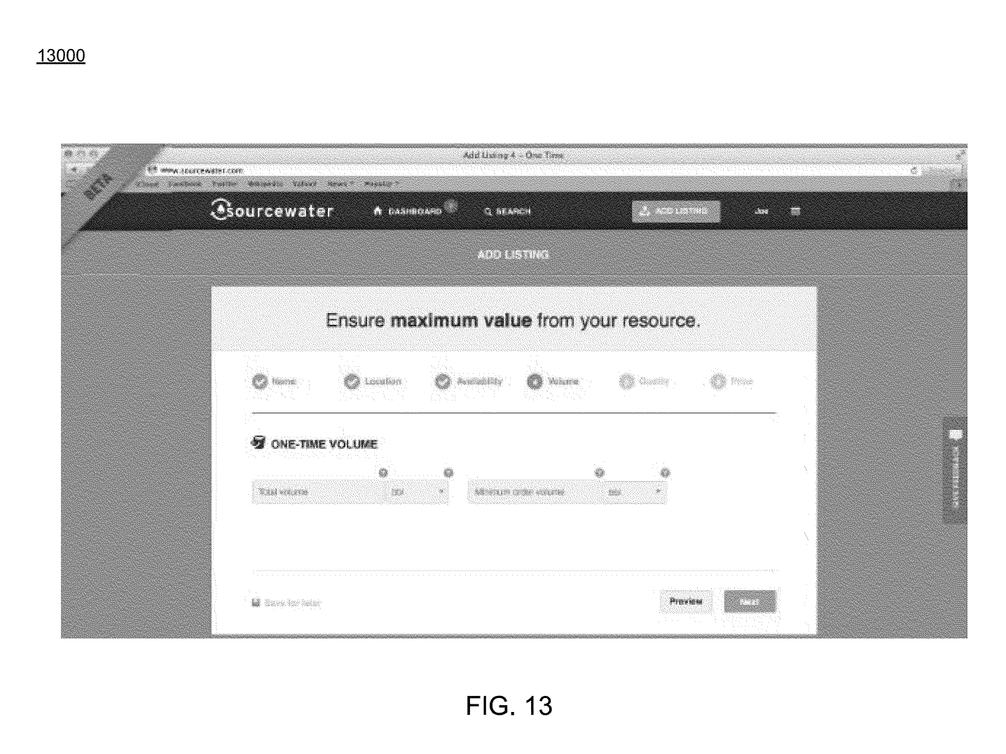

FIG. 13 illustrates another example screen 13000 of an online water exchange platform, consistent with the embodiments presented herein. As illustrated in screen 13000, a user with a water resource available may enter attributes regarding a volume of water that is available. For example, because the user in screen 12000 selected that the water was only available one time, screen 13000 allows the user to enter the volume available for the one time purchase. For example, screen 13000 illustrates that the user may select a total volume of water available for the one time purchase, and a minimum volume available for the one time purchase. The user may then select a button (e.g., “Next”) to proceed to the next screen (e.g., screen 14000).

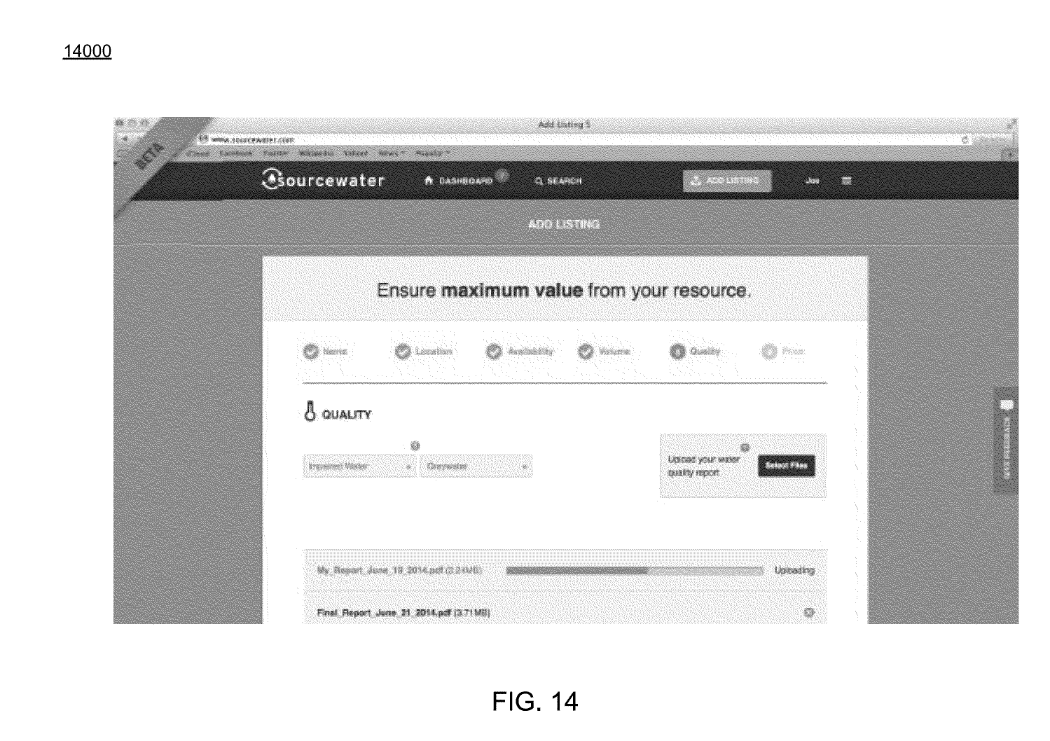

FIG. 14 illustrates another example screen 14000 of an online water exchange platform, consistent with the embodiments presented herein. As illustrated in example screen 14000, a user with a water resource available may enter attributes regarding a type of the water. For example, as illustrated in screen 14000, the user has selected that the type of the water is impaired water, and that the sub type of the water is greywater. Screen 14000 also illustrates that the user is uploading a water quality report for the water. The user may then select a button (e.g., “Next”) to proceed to the next screen (e.g., screen 15000).

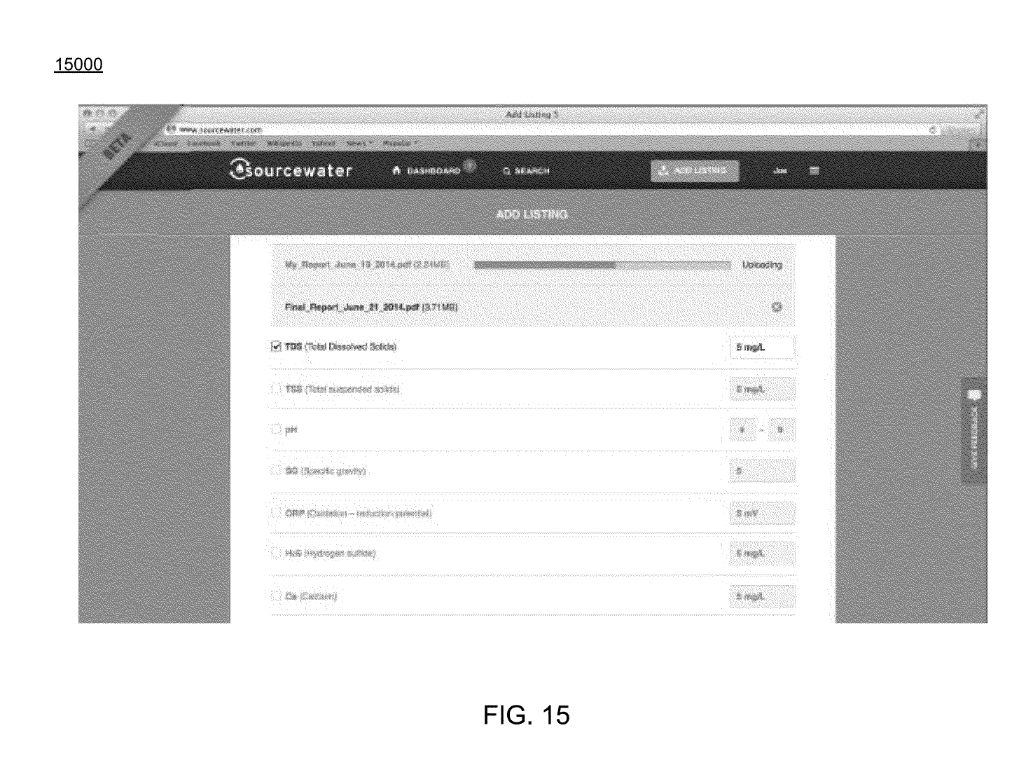

FIG. 15 illustrates another example screen 15000 of an online water exchange platform, consistent with the embodiments presented herein. As illustrated in example screen 15000, a user with a water resource available may enter attributes regarding a quality of the water. For example, as illustrated in screen 15000, the user is uploading a water quality report. As also illustrated in screen 15000, the user may select different characteristics of the water (e.g., TDS) and a value for the selected characteristic (e.g., 5 mg/L).

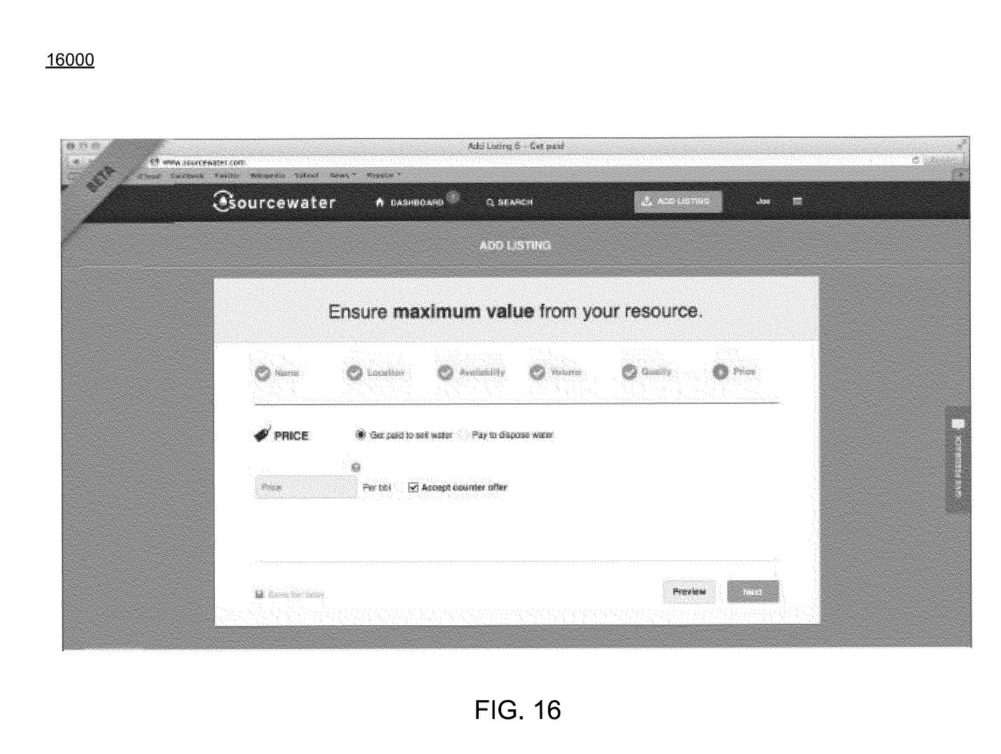

FIG. 16 illustrates another example screen 16000 of an online water exchange platform, consistent with the embodiments presented herein. As illustrated in example screen 16000, a user with a water resource available may enter trade conditions for the water. For example, as illustrated in screen 16000, the user may select a price for the water, such as a price per barrel of the water. The user may also select whether he/she will accept counter offers. The user may further select whether he/she is offering to sell water with the specified attributes, or is offering to dispose of water with the specified attributes. The user may then select a button (e.g., “Next”) to proceed to the next screen (e.g., screen 17000).

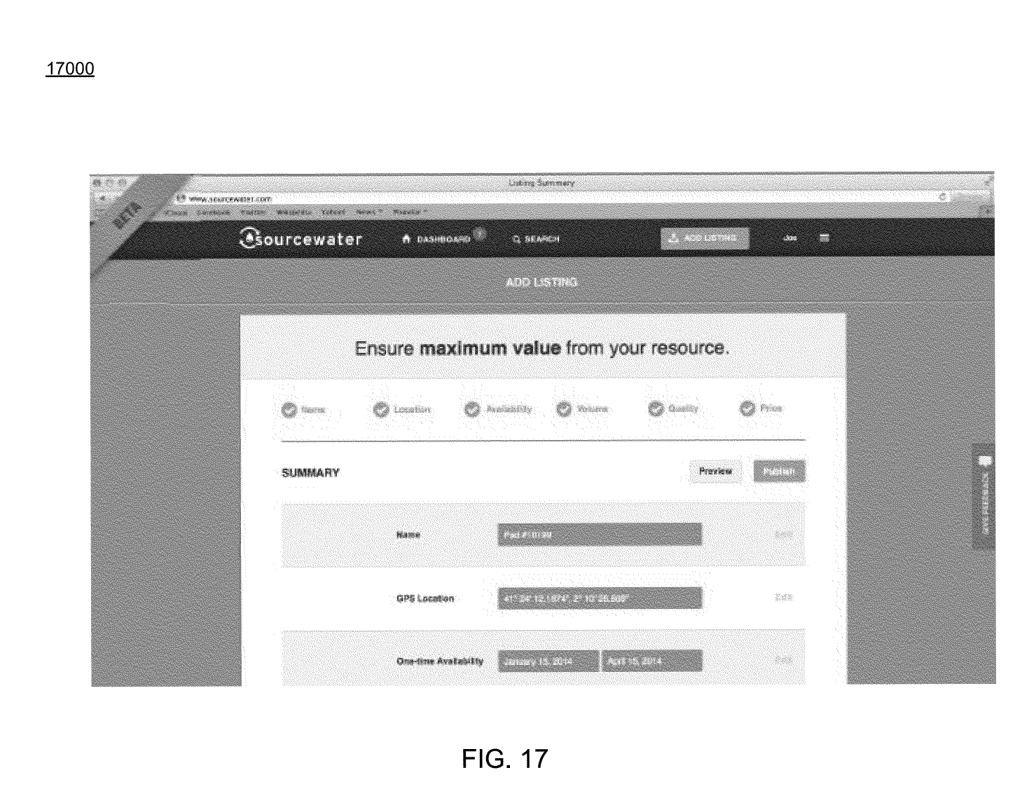

FIG. 17 illustrates another example screen 17000 of an online water exchange platform, consistent with the embodiments presented herein. As illustrated in example screen 17000, a user with a water resource available may receive a summary of the information the user has entered before he publishes availability of the water resource into the platform. For example, as illustrated in screen 17000, the name, location, and dates for one-time purchase of the water resource may be displayed to the user. The user may then select a button (e.g., “Publish”) to publish the availability of the water resource on the platform.

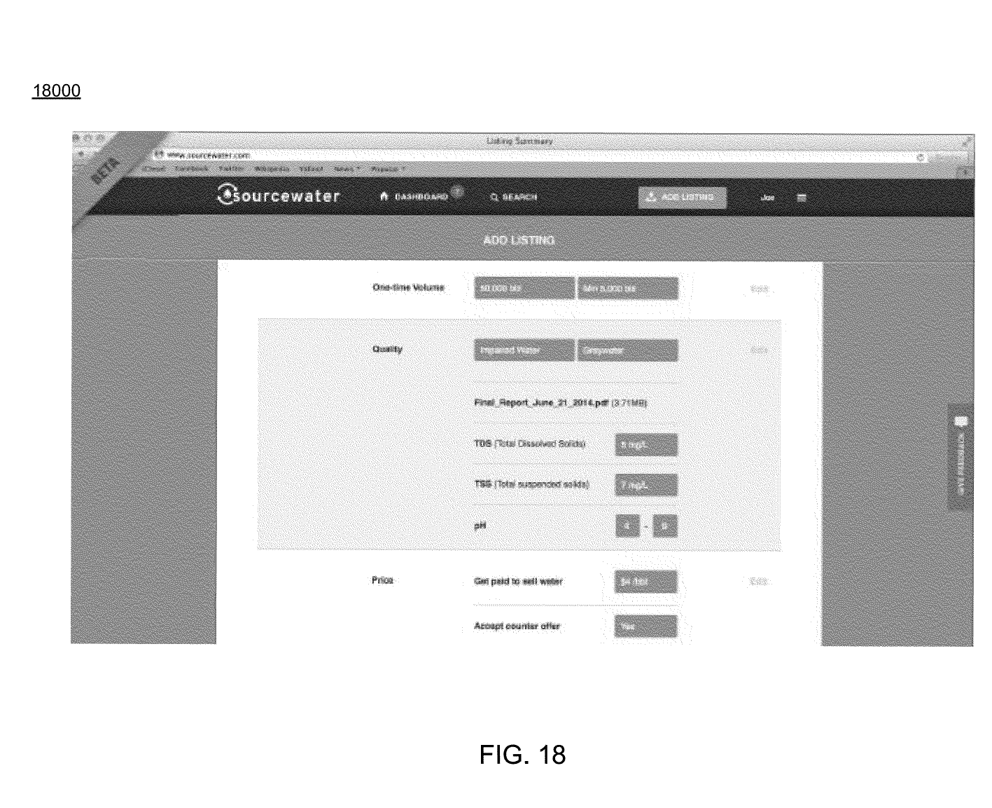

FIG. 18 illustrates another example screen 18000 of an online water exchange platform, consistent with the embodiments presented herein. Example screen 18000 may be a screen that the user views when scrolling down from screen 17000. As illustrated in example screen 18000, a user with a water resource available may be provided with additional summary details about the water resource before he publishes it onto the platform. For example, screen 18000 illustrates that the user may be provided with the total one time volume available, the minimum volume allowed for a purchase, the type and sub type of the water, the water quality report, values for quality of the water (e.g., TDS and TSS values), values for pH levels of the water, the price at which the user is offering the water, and whether the user will accept a counteroffer.

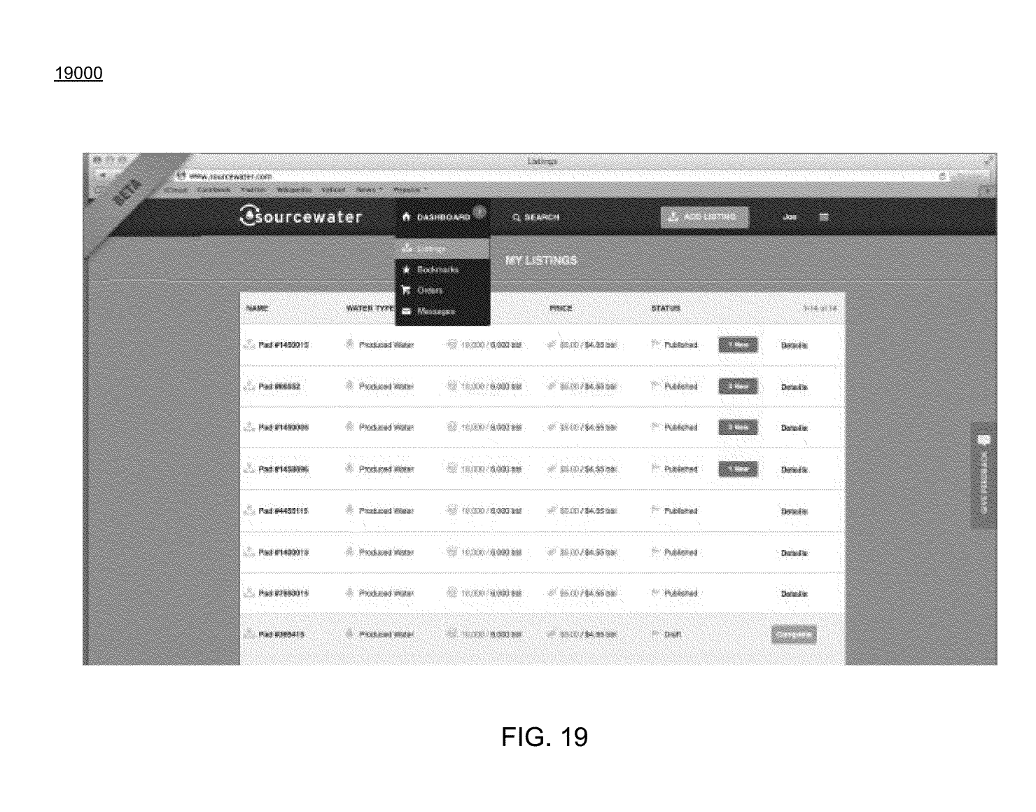

FIG. 19 illustrates another example screen 19000 of an online water exchange platform, consistent with the embodiments presented herein. As illustrated in example screen 19000, a user with water resources available may view his/her current listings on the online water resource exchange platform.

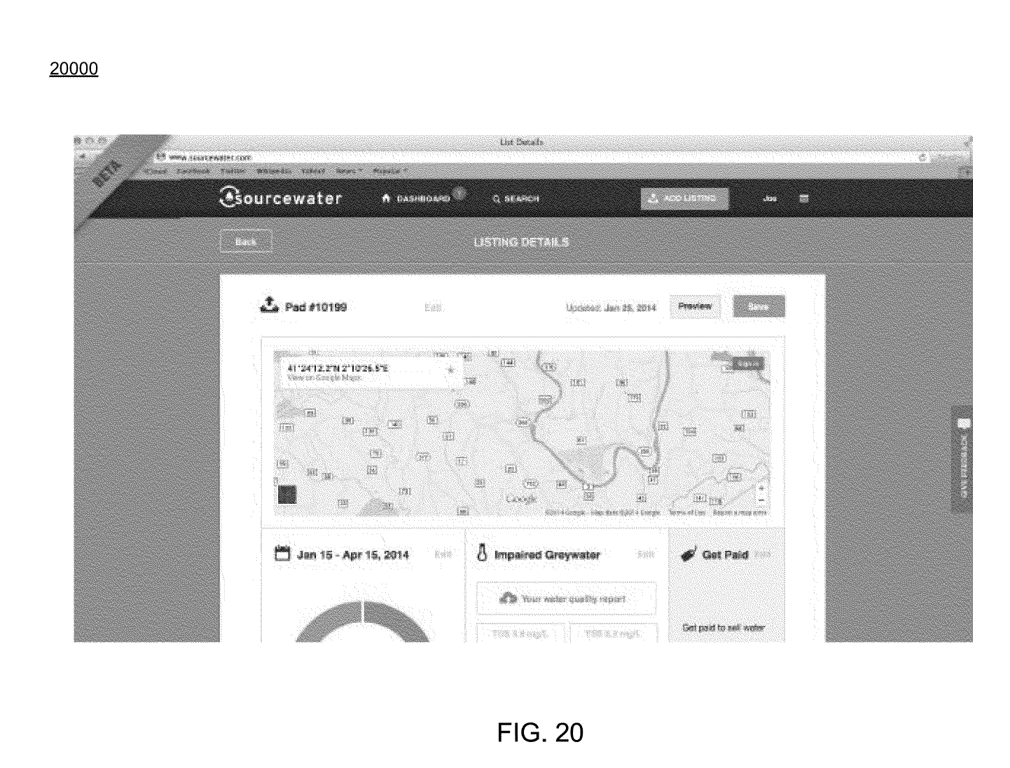

FIG. 20 illustrates another example screen 20000 of an online water exchange platform, consistent with the embodiments presented herein. As illustrated in example screen 20000, a user may select a listing and view details of the listing, including a map illustrating where the water resource is located.

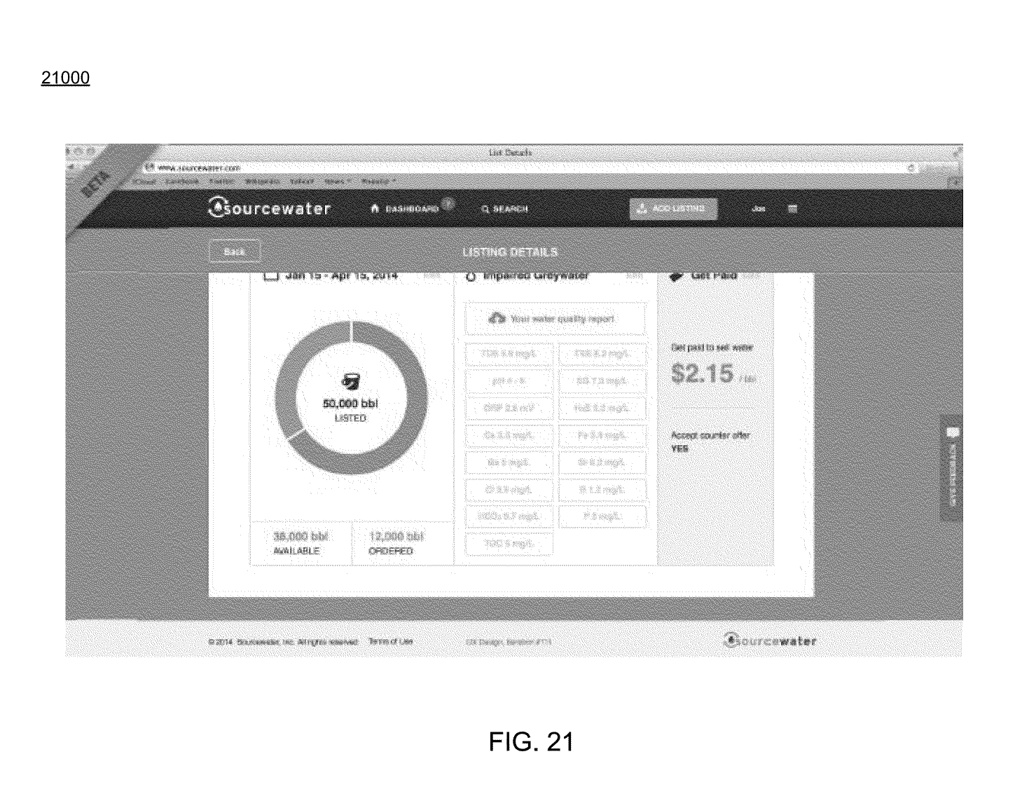

FIG. 21 illustrates another example screen 21000 of an online water exchange platform, consistent with the embodiments presented herein. As illustrated in example screen 21000, a user may view details for one of his/her water resources that is offered for sale. For example, screen 21000 illustrates that 12,000 barrels of the illustrated resource has been purchased, and 38,000 barrels are still available for purchase.

Although particular screens are illustrated in FIGS. 6-21, as described above, the disclosure is not limited to implementations illustrated in these screens. One of skill in the art would recognize that a variety of different types of screens, buttons, and fields could be provided to implement the embodiments disclosed herein.

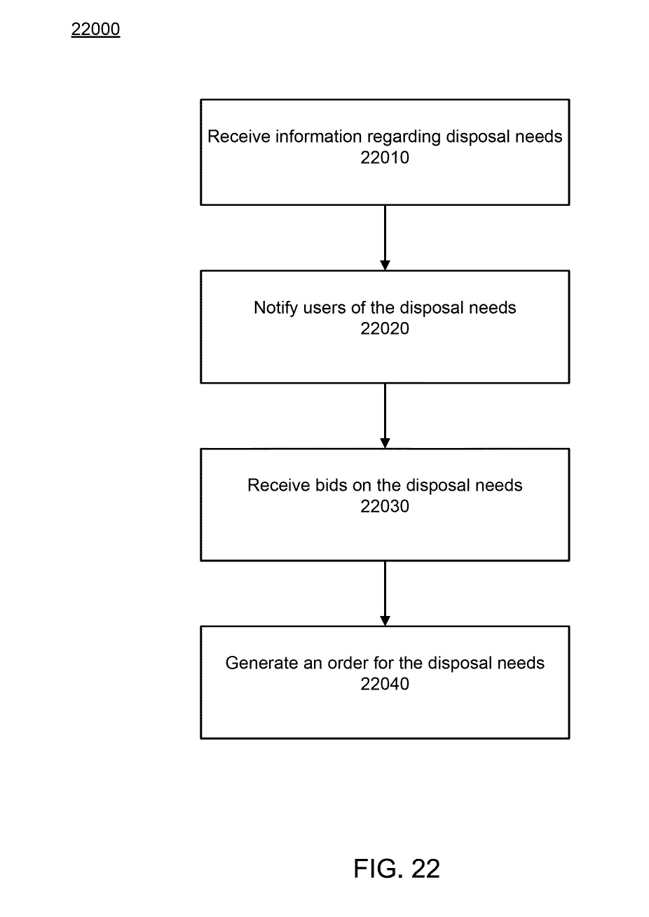

FIG. 22 illustrates a flowchart of another example method 22000, consistent with embodiments of the present disclosure. Example method 22000 may be implemented in a computing environment (see, e.g., FIG. 3) using one or more computer systems (see, e.g., FIG. 23). In some embodiments, method 22000 may be performed by one or more servers 2030.

In step 22010, information may be received from a user regarding disposal needs, such as wastewater disposal needs. For example, the information may include one or more attributes regarding the disposal needs, such as a volume of the water to be disposed, a type of the water to be disposed, a sub type of the water to be disposed, a quality of the water to be disposed, and/or a price the user is willing to pay for the disposal. In step 22020, the disposal needs of the user may be sent to other users to determine whether any of the other users of the system may wish to handle the user's disposal needs. For example, in one embodiment, the water exchange platform may publish the user's disposal needs, so that other users of the platform may see the user's needs. In step 22030, bids may be received from users interested in handling the user's disposal needs. For example, the user with the disposal needs may indicate he needs the matter to be disposed of in the near future, such as within the same day. Other users of the system may recognize that they have excess disposal capacity that day, and may bid to offer their extra capacity to dispose of the matter for the user. This way users with extra capacity can utilize their capacity to make extra money, and users without extra capacity can manage to get the matter disposed of for lower prices than they otherwise would be able to. Once the bids have been received, a determination can be made as to which bid will win. A number of different factors could be taken into account in determining which bid wins, such as which bid had the lowest price, which bid can dispose of the matter most quickly, etc. Once the winning bid has been selected, an order for the disposal needs may be generated. For example, the order may be automatically generated using techniques, such as those described with respect to FIG. 1.

FIG. 23 is a block diagram illustrating an example computer system 2300 that may be used for implementing embodiments consistent with the present disclosure, including the example systems and methods described herein. Computer system 2300 may include one or more computing devices 23010. Computer system 23000 may be used to implement client device(s) 2010, 2015, 2020 and/or server(s) 2030. The arrangement and number of components in computer system 2300 is provided for purposes of illustration. Additional arrangements, number of components, or other modifications may be made, consistent with the present disclosure.

As shown in FIG. 23, a computing device 23010 may include one or more processors 23020 for executing instructions. Processors suitable for the execution of instructions may include, by way of example, both general and special purpose microprocessors, and any one or more processors of any kind of digital computer. A computing device 23010 may also include one or more input/output (I/O) devices 23030. By way of example, I/O devices 23030 may include keys, buttons, mice, joysticks, styluses, etc. Keys and/or buttons may be physical and/or virtual (e.g., provided on a touch screen interface). A computing device 23010 may also be connected to one or more displays (not shown) via I/O 23030. A display may be implemented using one or more display panels, which may include, for example, one or more cathode ray tube (CRT) displays, liquid crystal displays (LCDs), plasma displays, light emitting diode (LED) displays, touch screen type displays, projector displays (e.g., images projected on a screen or surface, holographic images, etc.), organic light emitted diode (OLED) displays, field emission displays (FEDs), active matrix displays, vacuum fluorescent (VFR) displays, 3-dimensional (3-D) displays, electronic paper (e-ink) displays, or any combination of the above types of displays.

A computing device 23010 may include one or more storage devices configured to store data and/or software instructions used by processor(s) 23020 to perform operations consistent with disclosed embodiments. For example, a computing device 23010 may include main memory 23040 configured to store one or more software programs that, when executed by processor(s) 23020, cause processor(s) 23020 to perform functions or operations consistent with disclosed embodiments.

By way of example, main memory 23040 may include NOR and/or NAND flash memory devices, read only memory (ROM) devices, random access memory (RAM) devices, etc. A computing device 23010 may also include one or more storage mediums 23050. By way of example, storage medium(s) 23050 may include hard drives, solid state drives, tape drives, redundant array of independent disks (RAID) arrays, etc. Although FIG. 23 illustrates only one main memory 23040 and one storage medium 23050, a computing device 23010 may include any number of main memories 23040 and storage mediums 23050. Further, although FIG. 23 illustrates main memory 23040 and storage medium 23050 as part of computing device 23010, main memory 23040 and/or storage medium 23050 may be located remotely and computing device 23010 may be able to access main memory 23040 and/or storage medium 23050 via network(s) 2005.

Storage medium(s) 23050 may be configured to store data, and may store data received from one or more of client device(s) 2010, 2015, 2020 and/or server(s) 2030. The data may take or represent various content or information forms, such as documents, tables, lists, IP addresses, client device information, water resource information and attributes, software applications, files, and any other type of information and/or content which may be used in network applications, or any combination thereof.

A computing device 23010 may further include one or more communication interfaces 23060. Communication interface(s) 23060 may allow software and/or data to be transferred between client device(s) 2010, 2015, 2020 and server(s) 2030. Examples of communications interface 23060 may include a modem, network interface card (e.g., Ethernet card), communications port, personal computer memory card international association (PCMCIA) slots and cards, antennas, etc. Communications interface(s) 23060 may transfer software and/or data in the form of signals, which may be electronic, electromagnetic, optical, and/or other types of signals. The signals may be provided to/from communication interface(s) 23060 via a communications path (e.g., network(s) 2005), which may be implemented using wired, wireless, cable, fiber optic, radio frequency (RF), and/or other communications channels.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A computer-implemented method for facilitating an exchange of a water resource, comprising:
receiving over a network, by a computing device including a memory and a processor configured to execute instructions stored in the memory, first information identifying a plurality of attributes regarding a water resource to be offered for trade, wherein the first information is received from a first client device associated with a first entity that controls the water resource;
receiving, by the computing device over the network, second information identifying a plurality of attributes regarding a water resource need, wherein the second information is received from a second client device associated with a second entity that has the water resource need;
automatically calculating, by the processor, a cost associated with providing the water resource controlled by the first entity to the second entity based on the first information and the second information;
automatically generating, by the processor, a transaction proposal based on the calculated cost; and
providing the transaction proposal to the first client device for presentation to the first entity, or to the second client device for presentation to the second entity.

2. The method of claim 1, wherein the water resource to be offered for trade is a first water resource to be offered for trade, the cost is a first cost, and the transaction proposal is a first transaction proposal, further comprising:
receiving over the network, by the computing device, third information identifying a plurality of attributes regarding a second water resource to be offered for trade, wherein the third information is received from a third client device associated with a third entity that controls the second water resource;
automatically calculating, by the processor, a second cost associated with providing the second water resource to the second entity based on the third information and the first information;
automatically generating, by the processor, a second transaction proposal based on the second cost; and
providing the second transaction proposal to the third client device for presentation to the third entity, or to the second client device for presentation to the second entity.

3. The method of claim 1, wherein the plurality of attributes identified by the first information includes an attribute indicative of a location of the water resource to be offered for trade, an attribute indicative of an availability of the water resource to be offered for trade, and an attribute indicative of a trade condition of the water resource to be offered for trade.

4. The method of claim 1, wherein the plurality of attributes identified by the second information includes an attribute indicative of a location of the water resource need, an attribute indicative of a condition of the water resource need, and an attribute indicative of a trade condition of the water resource need.

5. The method of claim 1, wherein the cost is a first cost, further comprising:
receiving over the network, by the computing device, third information identifying a plurality of attributes regarding a transportation resource to be offered for trade, wherein the third information is received from a third client device associated with a third entity that controls the transportation resource;
automatically calculating, by the processor, a second cost associated with providing the water resource controlled by the first entity to the second entity based on the third information; and
automatically calculating, by the processor, the first cost associated with providing the water resource controlled by the first entity to the second entity based on the second cost, the first information, and the second information.

6. The method of claim 1, further comprising receiving over the network, by the computing device, third information indicative of an offer proposed by the first entity or the second entity based on the transaction proposal, the third information identifying a plurality of attributes relating to the offer.

7. The method of claim 6, further comprising receiving over the network, by the computing device, fourth information indicative of a term or condition related to the offer.

8. The method of claim 7, further comprising providing over the network, by the computing device, a contract template to the first client device or the second client device, wherein the contract template includes the term or condition.

9. The method of claim 8, further comprising automatically generating, by the processor, an order for the water resource controlled by the first entity by the second entity based on the contract template.

10. The method of claim 3, wherein the attribute indicative of the availability of the water resource to be offered for trade includes at least one of the following:
a volume of the water resource that is available;
a date on which the water resource is available;
a type of the water resource that is available; and
a quality metric of the water resource that is available.

11. The method of claim 3, wherein the attribute indicative of the trade condition includes at least one of the following:
a price of the water resource that is available;
a type of trade for the water resource that is available; and
a business negotiation method for the water resource that is available.

12. The method of claim 4, wherein the attribute indicative of a condition of the water resource need includes at least one of the following:
a volume of the water resource needed;
a date on which the water resource is needed;
a type of the water resource needed; and
a quality of the water resource needed.

13. The method of claim 4, wherein the attribute indicative of a trade condition of the water resource need includes at least one of the following:
a price of the water resource needed;
a type of trade for the water resource needed; and
a business negotiation method for the water resource needed.

14. The method of claim 5, wherein the plurality of attributes regarding the transportation resource to be offered for trade includes at least one of the following:
a type of transportation;
a loading time;
a loading cost; and
a price of transportation.

15. A computer-implemented system for facilitating an exchange of a water resource, comprising:
one or more memory devices that store instructions; and
one or more processors that execute the instructions to:
receive over a network first information identifying a plurality of attributes regarding a water resource to be offered for trade, wherein the first information is received from a first client device associated with a first entity that controls the water resource;
receive over the network second information identifying a plurality of attributes regarding a water resource need, wherein the second information is received from a second client device associated with a second entity that has the water resource need;
automatically calculate a cost associated with providing the water resource controlled by the first entity to the second entity based on the first information and the second information;
automatically generate a transaction proposal based on the calculated cost; and
provide the transaction proposal to the first client device for presentation to the first entity, or to the second client device for presentation to the second entity.

16. The system of claim 15, the one or more processors further executing the instructions to:
receive over the network third information identifying a plurality of attributes regarding a second water resource to be offered for trade, wherein the third information is received from a third client device associated with a third entity that controls the second water resource;
automatically calculate a second cost associated with providing the second water resource to the second entity based on the third information and the first information;
automatically generate a second transaction proposal based on the second cost; and
provide the second transaction proposal to the third client device for presentation to the third entity, or to the second client device for presentation to the second entity.

17. The system of claim 15, wherein the cost is a first cost, the one or more processors further executing the instructions to:
receive over the network third information identifying a plurality of attributes regarding a transportation resource to be offered for trade, wherein the third information is received from a third client device associated with a third entity that controls the transportation resource;
automatically calculate a second cost associated with providing the water resource controlled by the first entity to the second entity based on the third information; and
automatically generate the first cost associated with providing the water resource controlled by the first entity to the second entity based on the second cost, the first information, and the second information.

18. The system of claim 15, wherein the plurality of attributes identified by the first information includes an attribute indicative of a location of the water resource to be offered for trade, an attribute indicative of an availability of the water resource to be offered for trade, and an attribute indicative of a trade condition of the water resource to be offered for trade.

19. The system of claim 15, wherein the plurality of attributes identified by the second information includes an attribute indicative of a location of the water resource need, an attribute indicative of a condition of the water resource need, and an attribute indicative of a trade condition of the water resource need.

20. A non-transitory computer-readable medium storing instructions that, when executed by one or more processors, cause the one or more processors to perform a method for facilitating an exchange of a water resource, the method comprising:
receiving over a network first information identifying a plurality of attributes regarding a water resource to be offered for trade, wherein the first information is received from a first client device associated with a first entity that controls the water resource;
receiving over the network second information identifying a plurality of attributes regarding a water resource need, wherein the second information is received from a second client device associated with a second entity that has the water resource need;
automatically calculating a cost associated with providing the water resource controlled by the first entity to the second entity based on the first information and the second information;
automatically generating a transaction proposal based on the calculated cost; and
providing the transaction proposal to the first client device for presentation to the first entity, or to the second client device for presentation to the second entity.
